(19) United States
(12) Patent Application Publication
(10) Pub. No.: US 2003/0088471 A1
(43) Pub. Date: May 8, 2003

(54) Item-selecting device, computer-readable medium and item-selecting system

(75) Inventors: Yuji Tanigaki, Minato (JP); Chieko Kaeriyama, Minato (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/115,990

(22) Filed: Apr. 5, 2002

(30) Foreign Application Priority Data
Nov. 6, 2001 (JP) 2001-340486

(51) Int. Cl. G06F 7/00

(52) U.S. Cl. 705/20; 345/700

(57) ABSTRACT

An item-selecting device includes item data retriever, item selection receiving means, item combiner and output means. The item data retriever retrieves individual price information for items offered as single items and set price information for items offered as sets of items from an item information storing part. The item selection receiving means receives item selection information of a selection of items selected by a user that includes at least one single item and at least one set of items. The item combiner regroups the selection of items into at least one combination of items consisting of the same items as included in the selection and choosing a combination offered at lowest total price by referring to the individual price information and the set price information. The output means outputs the result obtained from the item combiner.

### BACKGROUND OF THE INVENTION

1. Field of the Invention

The present invention relates to an item-selecting device for customers to select items and particularly relates to an item-selecting device, a computer readable medium and an item-selecting system for retrieving the lowest price, suggesting the profitable or best-buy items and reducing the total time required for ordering.

2. Description of the Related Art

At fast-food restaurants, a customer orders items at a counter where the items and/or a menu are is displayed. When the customer has decided which items to order, he/she identifies the selected items to a shop assistant and the shop assistant inputs data of the selected items into a cash register.

In such a presently carried out process, the customer does not know the items or the menu until he/she stands in front of the counter. Then the customer begins to select items, therefore it takes a long time for the customer to select items at the counter. This is disadvantageous particularly for fast-food restaurants where items are often prepared in advance to provide them to the customers as quickly as possible, since a flow rate of the customers depends on time taken for the customers to select items. Accordingly, a high flow rate of customers cannot be achieved with a conventional manner of selecting items.

Also, as for the customer, he/she must select items within a short time interval while he/she is standing in front of the counter. However, a lot of fast-food restaurants offer various items as sets which are offered at a lower price than the total price of each of the content items. The items provided as sets of items may confuse the customer in determining which combination of items is truly a best-buy.

### SUMMARY OF THE INVENTION

Accordingly, it is a general object of the present invention to provide an item-selecting device that can obviate the problems described above.

It is another and more specific object of the present invention to provide an item-selecting device that can improve customer flow rate and provide items to the customer at lowest total prices.

In order to achieve the above objects, an item-selecting device includes:

item data retriever for retrieving individual price information for items offered as single items and set price information for items offered as sets of items from an item information storing part;

item selection receiving means for receiving item selection information of items selected by a user, the items selected including at least one single item and at least one set of items;

item combiner for regrouping the selection of items into at least one combination of items consisting of the same items as included in the selection and choosing a combination offered at lowest total price by referring to the individual price information and the set price information; and

output means for outputting the result obtained from the item combiner.

With the item-selecting device described above, the item data retriever retrieves item data such as name, price and contents from the item database using the result from the item selection receiving means as a key. The order is input to the cash register by reading information output by the output means at the information-selecting device. Therefore, at the shop, the customer has only to hand the output to a shop assistant for ordering. The customer does not have to spend time in front of the counter to select item he/she wishes to order. Thus, since the time required for the customer to select items in front of the counter is eliminated, the customer flow rate can be improved.

The present invention is also advantageous for the customer since the item-selecting device automatically regroups the selected items into a combination of items at the lowest total price. The item combining means changes selected items for set items so that the customer can buy his/her selected items at the lowest price. Item information of contents is retrieved from the item information database using the result obtained from the item selection receiving means as a key. If the customer selects set items, this means that the contents of set item data are retrieved from the information database. On the basis of the retrieved data, the item combining means regard each content of the set items as a single item. Then the item combining means combines the single items into a maximum possible number of combinations that can be achieved using the single items. The item combing means outputs the combined set of items that is offered at the lowest price.

Therefore, the customer only selects desired items using the item-selecting device and does not have to determine which combination of items is offered at the lowest price. Accordingly, the customer can quickly select the items. The more the customers selects items using the item-selection device, the less the time required for ordering items at the counter becomes. Therefore, the customer flow rate can be increased.

### BRIEF DESCRIPTION OF THE DRAWINGS

FIG. 1 is a schematic diagram showing a system of the present invention.

FIG. 2 is a perspective view of an item-selecting device of the present invention.

FIG. 3 is a block diagram showing an item-selecting device of a first embodiment of the present invention.

FIG. 4 is a block diagram showing a cash register of the first embodiment of the present invention.

FIG. 5 is a block diagram showing a server of the first embodiment of the present invention.

FIG. 6 is a table showing item information of hamburgers as single items.

FIG. 7 is a table showing single item information of side dishes.

FIG. 8 is a table showing single item information of drinks.

FIG. 9 is a table showing set item information.

FIG. 10 is a table showing best-buy set item information.

FIG. 11 is a table showing equivalent item correspondence information.

FIG. 12 shows an example of a screen displayed on the first display according to the first embodiment of the present invention.

FIG. 13 is a main flowchart of an item-selecting operation according to the first embodiment of the present invention.

FIG. 14 is a detailed flowchart of an item-selecting operation according to the first embodiment of the present invention.

FIG. 15 shows an example of a screen shown on the second display according to the first embodiment of the present invention.

FIG. 16 shows an example of a screen shown on the second display according to the first embodiment of the present invention.

FIG. 17 shows an example of a screen shown on the second display according to the first embodiment of the present invention.

FIG. 18 shows an example of a screen shown on the second display according to the first embodiment of the present invention.

FIG. 19 shows an example of a print result obtained according to the first embodiment of the present invention.

FIG. 20 is a schematic diagram showing a principle of an operation of regrouping selected items into a combination of items offered at the lowest total price according to the first embodiment of the present invention.

FIG. 21 is another schematic diagram showing a principle of an operation of regrouping selected items into a combination of items offered at the lowest total price according to the first embodiment of the present invention.

FIG. 22 shows an example of a screen shown on the second display according to the first embodiment of the present invention.

FIG. 23 shows an example of a screen shown on the second display according to the first embodiment of the present invention.

FIG. 24 is a flowchart of an item-selecting operation performed at a cash register according to the first embodiment of the present invention.

FIG. 25 is a flowchart of an information-updating operation according to the first embodiment of the present invention.

FIG. 26 is a block diagram showing an item-selecting device of a second embodiment of the present invention.

FIG. 27 is a block diagram showing a cash register of the second embodiment of the present invention.

FIG. 28 is a block diagram showing a server of the second embodiment of the present invention.

FIG. 29 is a main flowchart of an item-selecting operation according to the second embodiment of the present invention.

FIG. 30 is an example of a screen shown on the second display according to the second embodiment of the present invention.

FIG. 31 is another example of a screen shown on the second display according to the second embodiment of the present invention.

FIG. 32 is an example of a screen shown on a browser of a personal computer according to the second embodiment of the present invention.

FIG. 33 is another example of a print result obtained according to the first and second embodiments of the present invention.

### DETAILED DESCRIPTION OF THE PREFERRED EMBODIMENTS

In the following, principles and embodiments of the present invention will be described with reference to the accompanying drawings.

The following description relates to a first embodiment of the present invention. The present embodiment relates to an item-selecting system used at fast-food restaurants. In the following description, a hamburger shop is taken as an example of a fast-food restaurant. However, it should be understood that the present invention is not limited to fast-food restaurants such as hamburger shops, but may also be applied to other shops where customers select items in a similar manner.

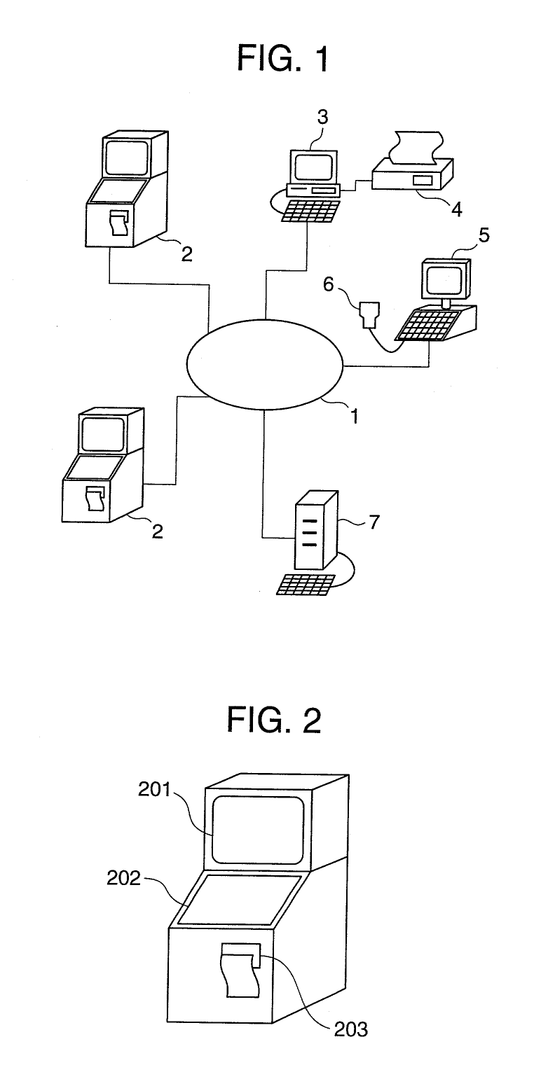

FIG. 1 is a schematic diagram showing a system of the present invention. The system includes a network 1 whereto at least one item-selecting device 2, a personal computer 3, at least one cash register 5 and a server 7 are connected. The item-selecting device 2 is operated by a customer wishing to order items. As shown in FIG. 2, which is a schematic external view of an item-selecting device 2 of the present invention, the item-selecting device 2 includes a first display 201, a second display 202 and printing part 203. On the first display 201, information as commercials is occasionally displayed as moving pictures or as a still picture. The second display 202 is provided with a touch panel. The printing part 203 prints the result obtained from the item-selecting device, which the customer finally ordered. The customer can used this printed paper as an order sheet. There may be several item-selecting devices installed inside or outside the hamburger shop. The customer selects items by operating the item-selecting device 2 and obtains an order sheet printed by a printing part 203. Then, the customer takes the order sheet to a counter to order the items.

As shown in FIG. 1, a printer 4 is connected to the personal computer 3. The cash register 5 is installed at the counter of the hamburger shop. A bar-code scanner 6 is connected to the cash register 5. In the first embodiment of the present invention, the server 7 manages the whole data of items offered at the shop. In the following, the constituents of the item-selecting system will be described in detail.

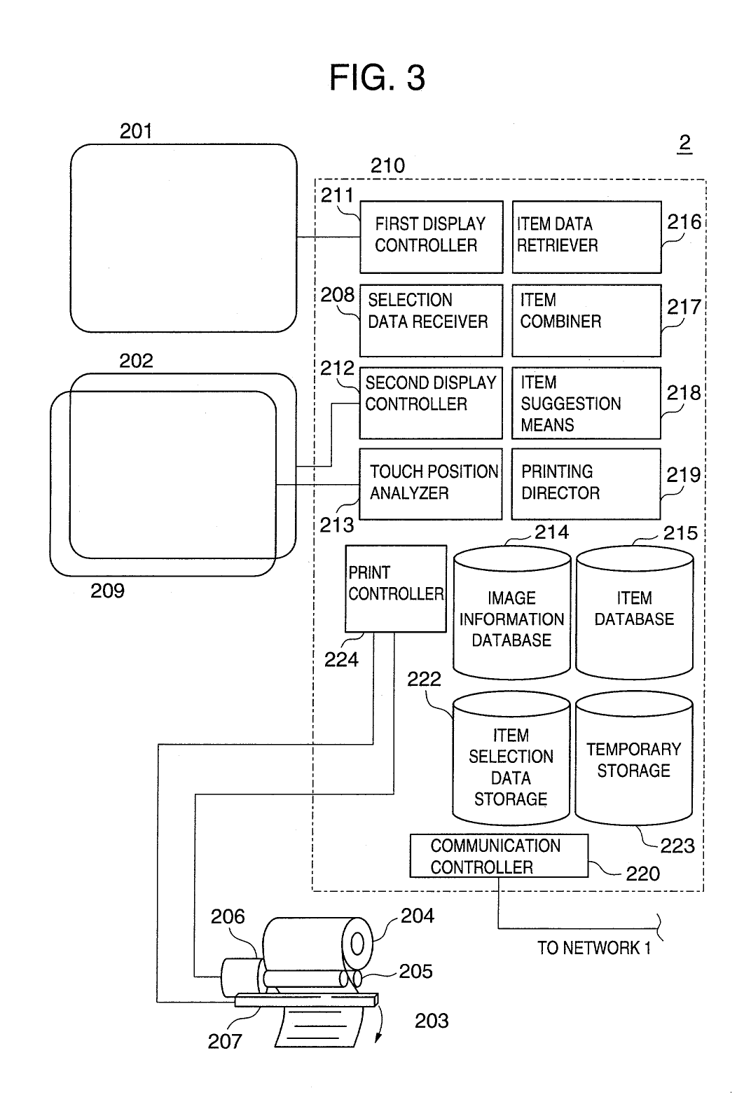

The configuration of the item-selecting device 2 will be described with reference to FIG. 3. In FIG. 3, the first display 201 and the second display 202 are the same as those described above with reference to FIG. 2, and will not be described in detail. The printing part is similar to the printing part 203 described above with reference to FIG. 2. The printing part 203 includes rollers 205 for transporting a paper roll 204, a motor 206 for driving the rollers 205 and a print head 207. A print controller 224 controls the motor 206 and the print head 207 to print on the paper roll 204. A touch panel 209 is equipped on the second display 202.

The item-selecting device 2 is controlled by control means 210 that includes various elements 208, 211 through 220 and 222 through 224 described below. The first display controller 211 controls the first display 201. The second display controller 212 controls the second display 202. The touch position analyzer 213 detects a touch position when the customer touches the touch panel 209. The selection data receiver 208 cooperates with the second display controller 212 and the touch position analyzer 213 so that the customer can select items as he/she wishes.

Image information to be displayed on the first display 201 is stored in the image information database 214. Various types of information about items (item information) are stored in the item database 215. The item data retriever 216 retrieves item data from the item database 215. The item combiner 217 retunes or regroups the items selected by the customer to a combination of items offered at the lowest total price. The item suggestion means 218 gives suggestions such as replacing some of the items selected by the customer with at least one different item in case where the customer has selected more than one of the same items and selecting a set of items that may be offered at a slightly higher price but with a good-buy impression. The printing director 219 gives printing directions for the print controller 224. The communication controller 220 controls communications over the network 1. The selected items data is stored in the item selection data storage 222. The temporary storage 223 temporarily stores the item data.

The item-selecting device 2 is a computer including programs and various means in the control means 210 are realized by executing a program for operating the item-selecting device as the various means.

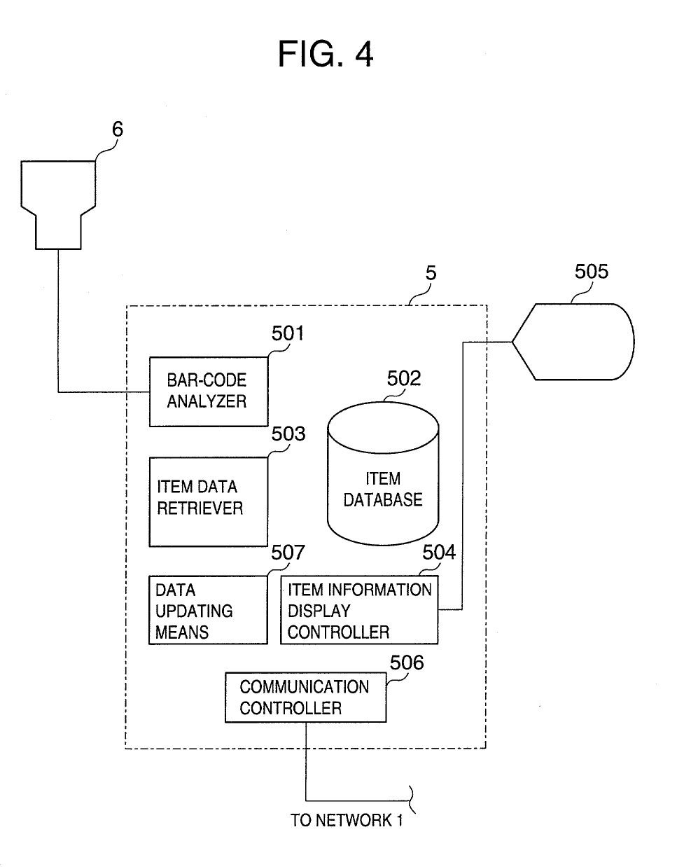

The configuration of the cash register 5 will be described with reference to the block diagram shown in FIG. 4.

As shown in FIG. 4, the bar-code scanner 6 is connected to the cash register 5. The bar-code scanner 6 scans bar-code data printed by the item-selecting device 2. The scanned data is analyzed by bar-code analyzer 501 and converted to item codes. An item database 502 stores various types of data about items offered at the shop. Item data retriever 503 retrieves from the item database 502 the item information corresponding to the item code obtained from the bar-code analyzer 501. Item information output control means 504 is responsible for displaying the item information retrieved by the item data retriever 503 on a display 505. A communication controller 506 controls communications over the network 1. Data updating means 507 updates the item data in the item database 502 by receiving data from the server 7 via the network 1.

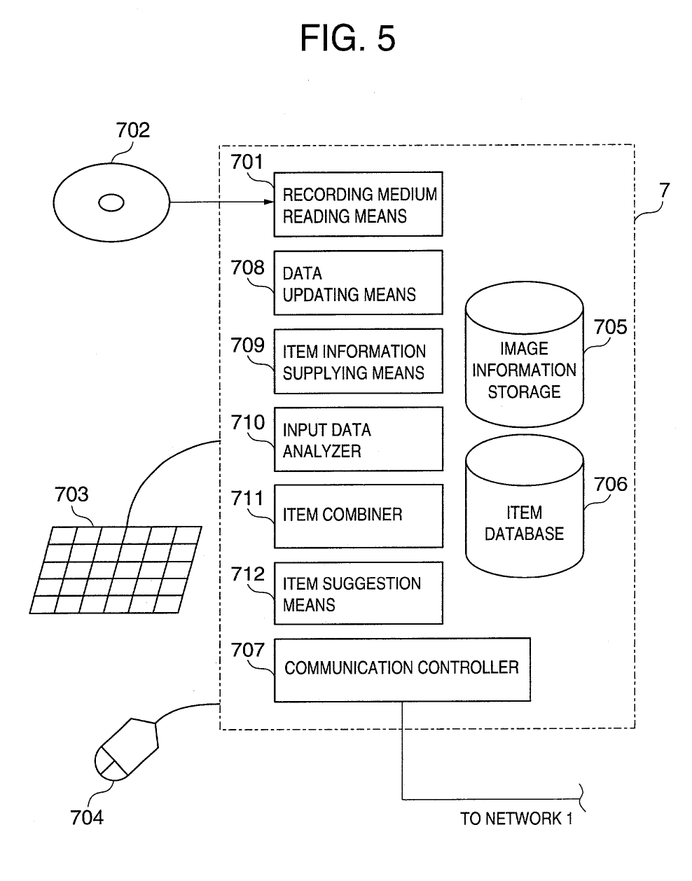

The configuration of the server 7 will be described with reference to FIG. 5.

As shown in FIG. 5, the server 7 includes various means 701, 707 through 712 and an image information database 705 and an item database 706. Storage medium reading means 701 such as a CD-ROM drive, a DVD-ROM drive and a magneto-optical drive (MO drive) is equipped for reading information on a storage medium 702 such as a CD-ROM, a DVD-ROM and a magneto-optical disk. Input analyzer 710 analyzes input data which is manually input via input means such as the keyboard 703 and the mouse 704.

An image information database 705 stores information to be displayed on the first display 201 of the item-selecting device 2. An item database 706 stores information related to various items offered at the shop. Communication controller 707 controls communications over the network 1.

Data updating means 708 controls the communication controller 707, which communicates with the item-selecting device 2, in order to update the item-selecting device 2 and the cash register 5. Item information supplying means 709 retrieves item information from the item database 706 in response to a request from the personal computer 3 and sends the retrieved item information to the personal computer 3 via the network 1.

An item combiner 711 regroups the items selected by the customer to a combination of items that may be offered at the lowest total price. Item suggestion means 712 gives suggestions such as replacing some of the items selected by the customer to at least one different item in a case where the customer has selected more than one of the same items and selecting a set of items that may be offered at a slightly higher price but with a good-buy impression. No detailed description has been made for the personal computer 3, but it is to be understood that the personal computer 3 is provided with at least access means (browser) for accessing the network and printing means for outputting screen information via the printer.

The item databases in the item-selecting device 2, the cash register 5 and the server 7 are configured as follows.

The item database includes single item information of various items (e.g., hamburger single item information 80, side-dish single item information 90 and drink single article information 100), set item information 110, “best-buy” set information 120 used to “select a set of items that may be offered at a slightly higher price but with a good-buy impression” and “equivalent item correspondence” information 130 used to “replace some of the items selected by the customer to at least one different item in a case where the customer has selected more than one of the same items.”

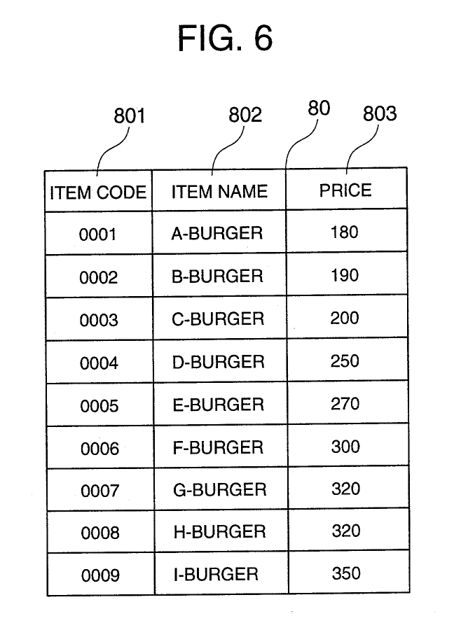

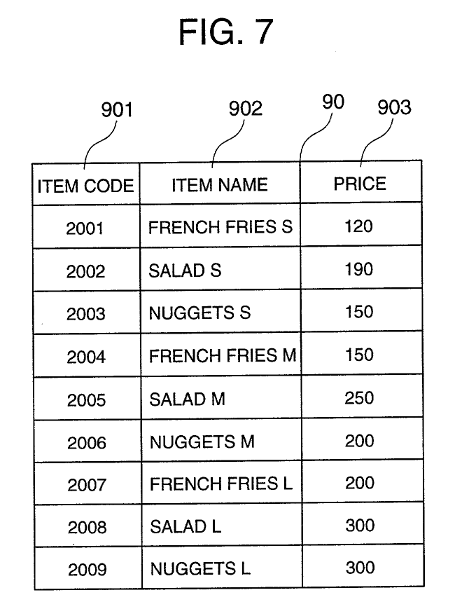

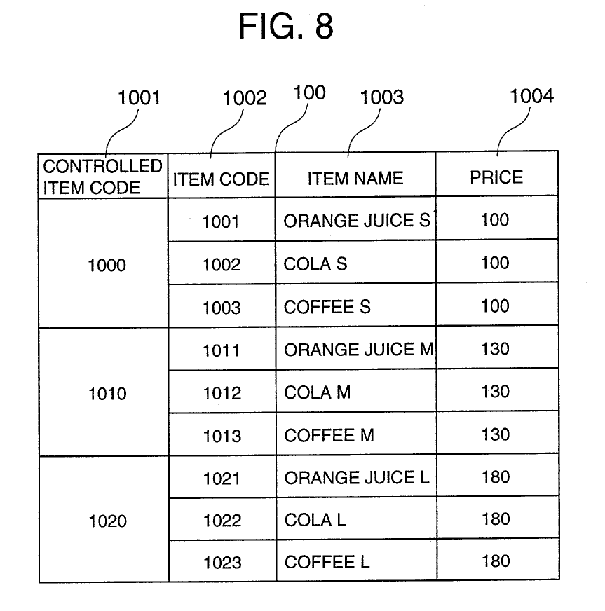

The information stored in the item information storing part will be described with reference to FIGS. 6 through 11. FIGS. 6 and 7 are tables of hamburger single item information 80 and side-dish single item information 90, respectively. The hamburger single item information 80 includes “item code” 801, “item name” 802 and “price” 803 for each item. The side-dish single item information 90 includes “item code” 901, “item name” 902 and “price” 903 for each item. The item code 801, 901 includes four digits with first through fourth digits being arranged such that the first digit is on the left. The first and second digits indicate type of item (e.g., “00” for hamburgers and “20” for side dishes) and the fourth digit indicates a number assigned to each item within a specific item type. FIG. 8 shows a table of single item information 100 of drinks. The drink single item information 100 includes “controlled item code” 1001, “item name” 1003 and “price” 1004 for each item.

The item code 1002 includes four digits arranged in a similar manner to the item codes of hamburgers and side dishes. The first and second digits indicate the item type (“10”) and the fourth digit indicates a number assigned to each item within the item type (e.g., “1” for “orange juice”, “2” for “cola” “3” for “coffee”). Also, the item name such as “orange juice” is accompanied by a character indicating the size, such as “S”, “M” and “L”. The size is indicated by the third digit of the item code. In the present embodiment, “S (small)” is indicated by “0”, “M (medium)” by “1” and “L (large)” by “2”. The relationship between the contents can be represented by: “S”<“M”<“L”.

The controlled item code 1001 is an item code assigned for each of the sizes described above and is also given by four digits arranged in the similar manner to other item codes. The first and second digits indicate the type of item as in the case of item code 1001, and the third and fourth digits indicate the size of item.

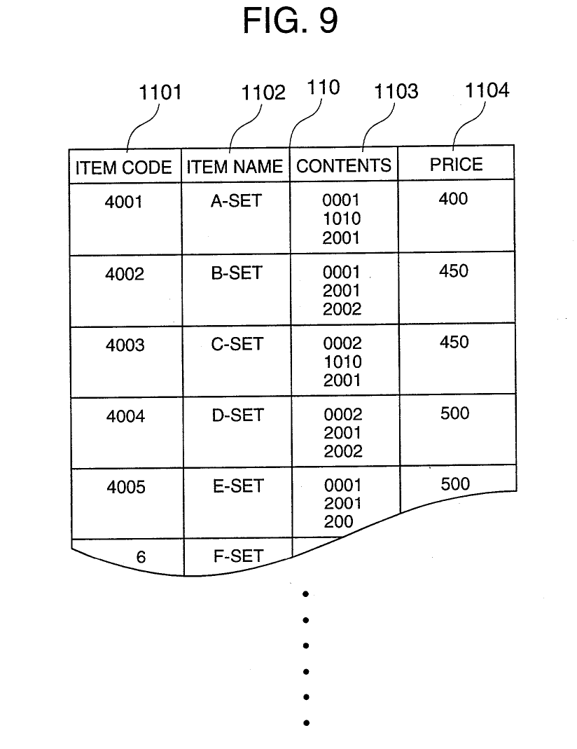

FIG. 9 is a table showing set item information 110. As is shown in FIG. 9, the set item information 110 includes “item code” 1101, “item name” 1102, “contents” of the set item 1193 and “price” 1104. The item code 1101 includes four digits arranged in a similar manner to the item codes 801, 901 of hamburgers and side dishes, respectively. The first and second digits indicate the item type (“40”) and the fourth digit indicates a number assigned to each item within the item type. The “contents” 1103 of the set item indicates items contained in the relevant set item and are indicated by the item codes 801 and 901 for the case of hamburgers and side dishes, respectively, and is indicated by the management item code 1001 for the case of drinks.

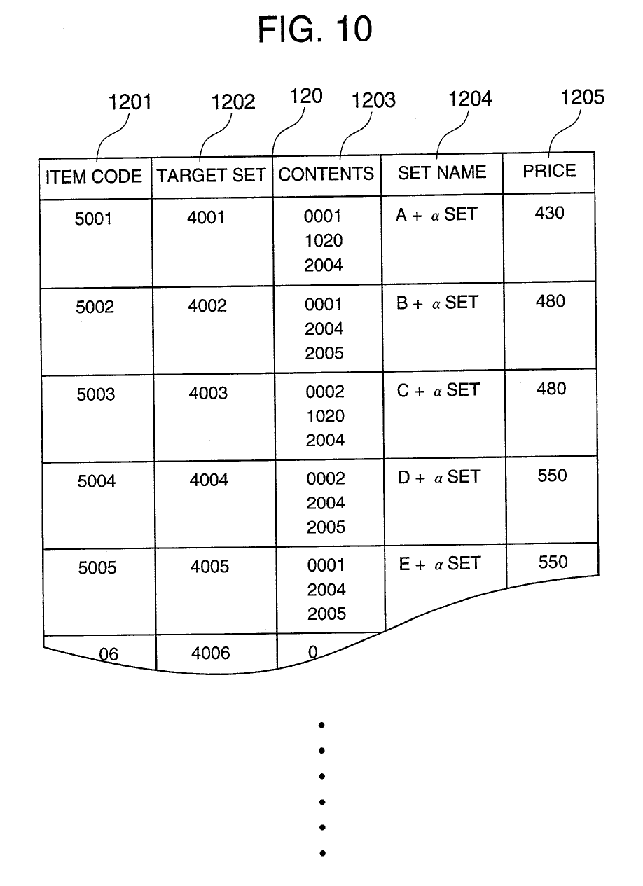

FIG. 10 is a table showing “best-buy” set information 120. As shown in FIG. 10, the best-buy information 120 includes “item code” 1201, “target set” 1202, “contents” 1203 of the set item, “set name” 1204 and “price 1205. The “item code” 1201 has four digits arranged in a similar manner to the item codes 801, 901 of hamburgers and side dishes, respectively. The first and second digits indicate the item type (“50”) and the fourth digit indicates a number assigned to each item within the item type. The “target set” 1202 indicates the item code of the set item to be used as the base. The “contents” 1203 of the set item is similar to the “contents” of the set item information 110 and indicates items contained in the relevant set item and are indicated by the item codes 801 and 901 for the case of hamburgers and side dishes, respectively, and is indicated by the management item code 1001 for the case of drinks.

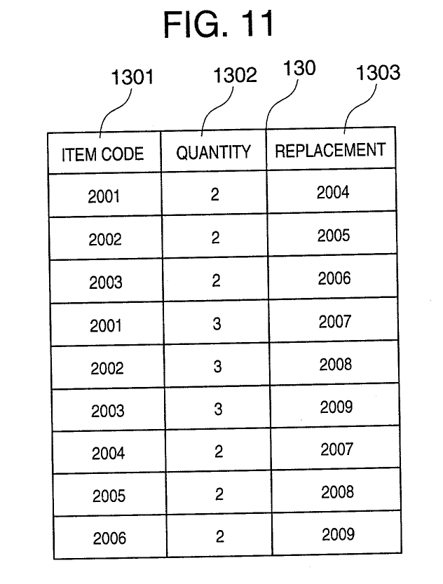

FIG. 11 is a table showing equivalent item correspondence information 130. The equivalent item correspondence information 130 includes “item code” 1301 of the item to be based on, “quantity” 1302 and “replacement” 1303 that is provided after replacement. This table indicates that, for example, ordering “two” “French fries S” (item code 2001) is equivalent to ordering “French fries M” (item code 2004). Such a replacement is preferable for items that may be shared between customers (In the present embodiment, such items are side-dish items). This is because it is meaningless to provide a larger size item instead of a plurality of smaller size items for items that are not shared between the customers (In the present embodiment, such items are hamburgers and drinks). It is unlikely to have to consider a case where the hamburgers of the same type that are ordered by two persons are replaced by a hamburger of a larger size. In other words, such a suggestion gives unnecessary choices that may confuse the customer and thus result in more time being required for the customer to make a selection.

In the following, an item selection operation performed by the item-selecting device 2 will be described.

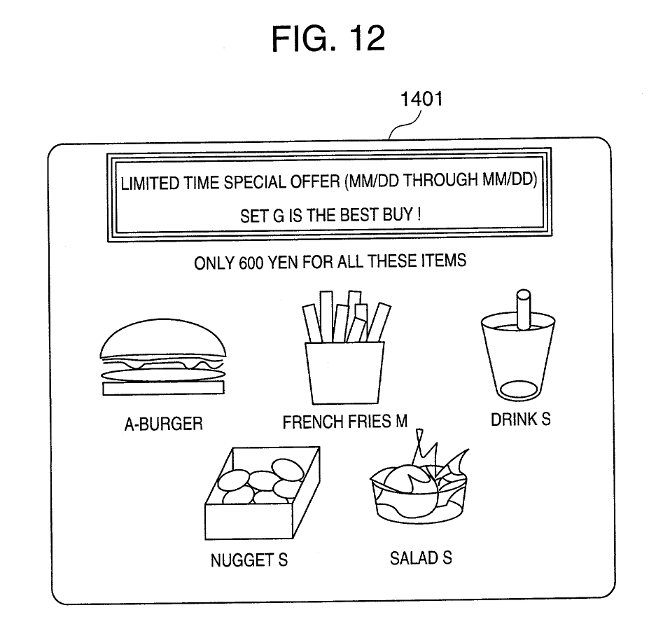

Before the item-selecting process of the present invention, information may be displayed on the first display 201. The first display controller 211 retrieves image information from the image information database 214 and displays the image information on the first display 201. The display operation of the first display 201 is performed independent of other operations. In the present embodiment, commercial information such as “best-buy information for a limited time” as indicated in FIG. 12 may be displayed on the first display 201. With such commercial information, the item-selecting device 2 of the present has an effect of increasing willingness to purchase items for those customers passing by the item-selecting device 2.

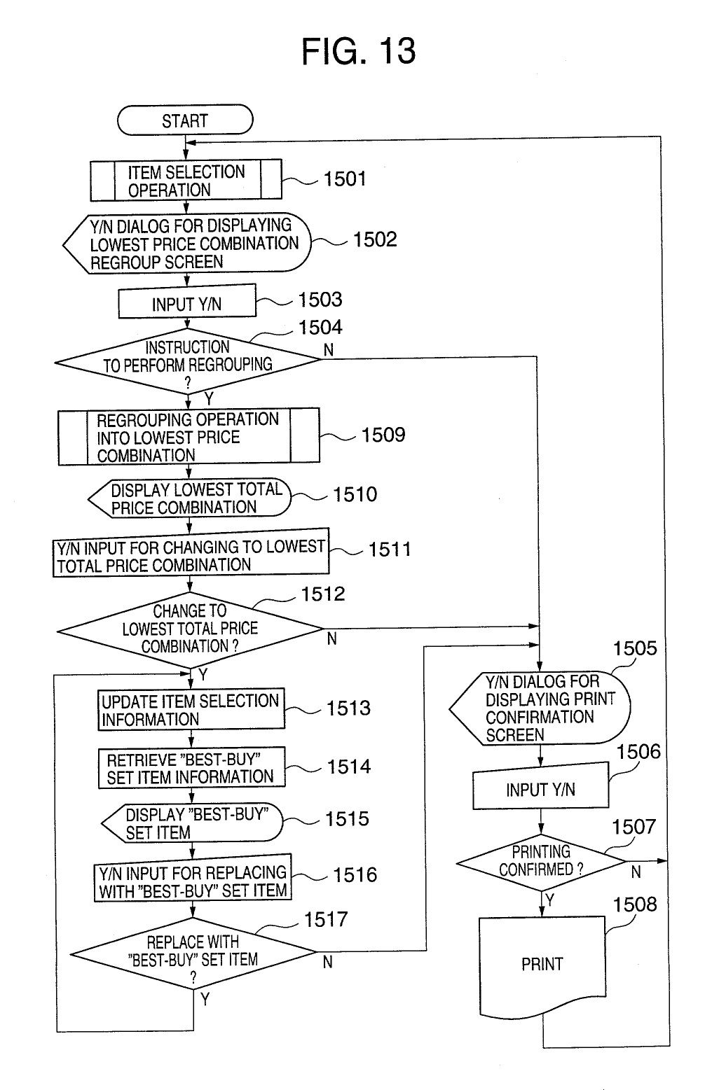

Referring to a main flowchart shown in FIG. 13, an item-selecting process of a principle of the present invention will be described.

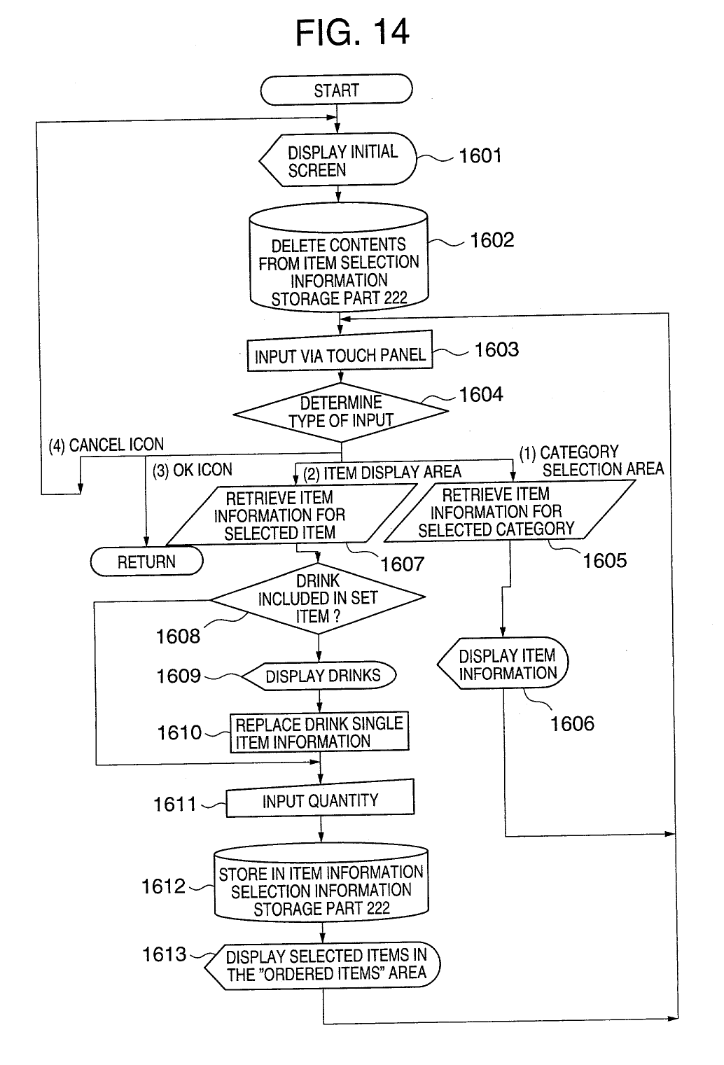

First, an item selection operation (step 1501) is performed by the selection data receiver 208 in the control means 210. The item-selecting operation (step 1501) will be described in detail with respect to the flowchart of FIG. 14.

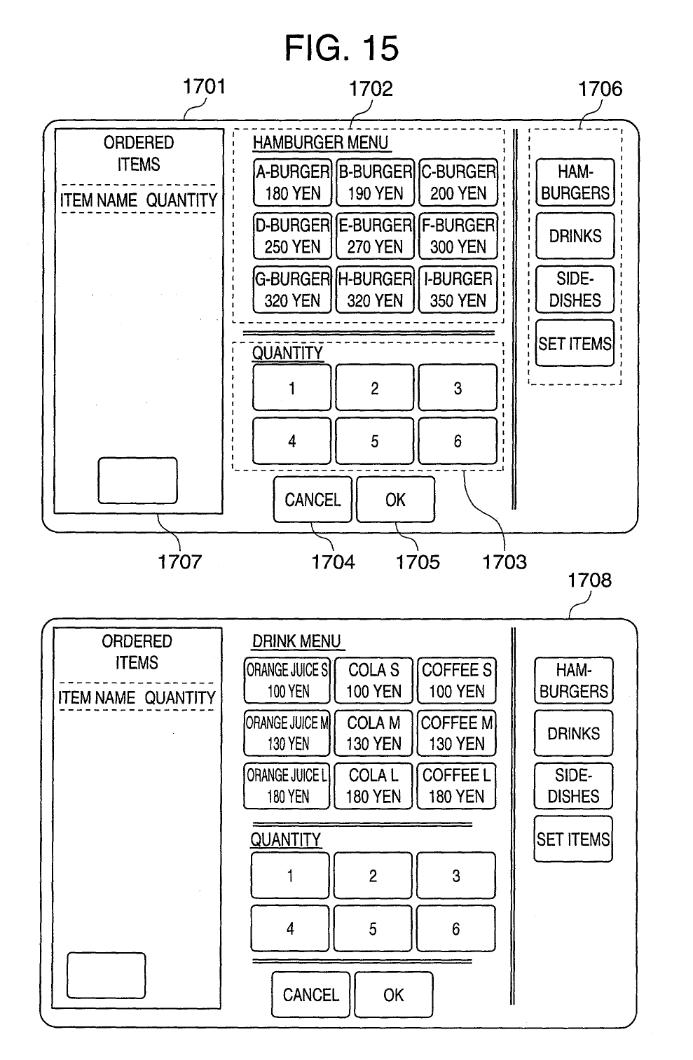

As shown in FIG. 14, first, an initial screen is displayed (step 1601). In the present embodiment, the initial screen is screen 1701 shown in FIG. 15 that relates to hamburgers. In order to display the initial screen, the item data retriever 216 retrieves item information related to hamburgers from the item database 215. The retrieved information is used by the second display controller 212 to display a screen, such as the screen 1701 shown in FIG. 15, on the second display 202. The screen 1701 includes an item display area 1702 for displaying information about items, a quantity display area 1703 for displaying quantity of items, a “cancel” icon 1704 for canceling item selection, an “OK” icon 1705 for verifying item selection, a category selection area 1706 for selecting a category of an item (hamburgers, drinks, side-dishes, set items) and an ordered item display area 1707 for displaying items that have been ordered by the customer.

Then, the content of the item selection data storage 222 is deleted (step 1602). This is to clear information related to the previous item selection. When the customer touches the touch panel 209 at a position corresponding to one of the icons on the second display 202, the touch position analyzer 213 detects the position information of the touch on the touch panel 209 (step 1603). Then, the position information and the display content displayed on the second display 202 is compared to determine types of the input (step 1604). In the following, branches (1) through (4) of step 1604 will be described.

(1) In a case where it is determined in step 1604 that the input is made by touching one of the icons in the category selecting region 1706:

In step 1605, it is determined which icon in the category selecting area 1706 has been touched and the item information for items in the category indicated on the icon is retrieved from the item database 215. The image displayed on the item display area 1702 is updated according to the retrieved item information (step 1606). Then the process returns to step 1603.

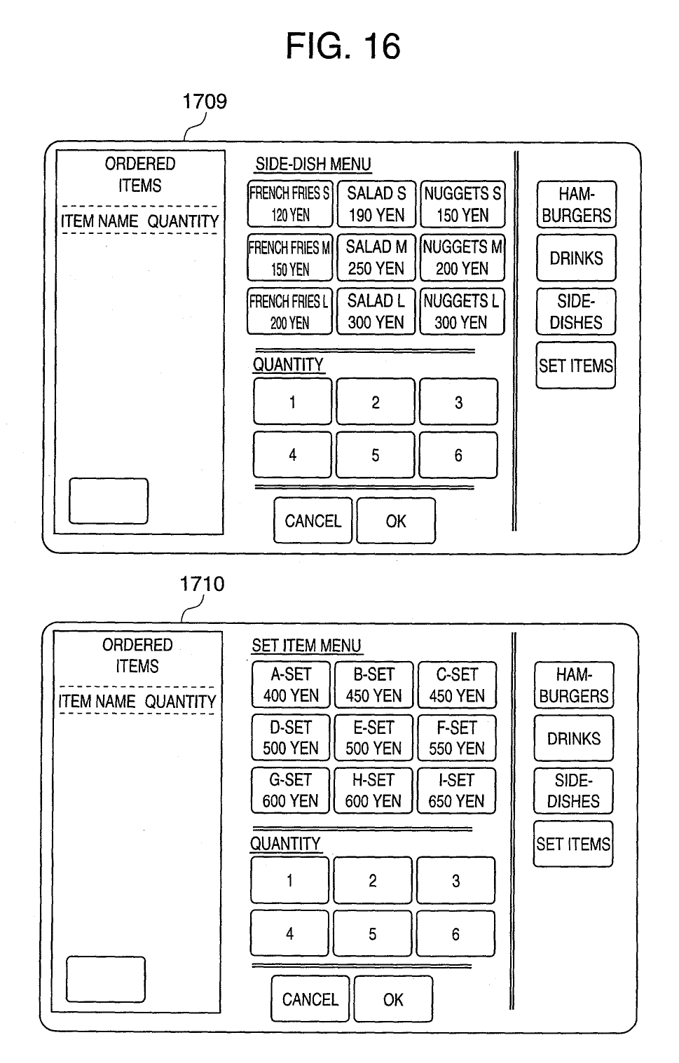

During the category selection process, when the “drink” icon is touched, the drink single item information 100 is retrieved and the item display area 1702 changes to a screen related to drinks as shown in a screen 1708 of FIG. 15. Similarly, when the “side-dish” icon is touched, the side-dish single item information 90 is retrieved and the item display area 1702 changes to a screen related to side-dishes as shown in a screen 1709 of FIG. 16. When the “set item” icon is touched, the set item information 110 is retrieved and the item display area 1702 changes to a screen related to set items as shown in a screen 1710 of FIG. 16.

(2) In a case where it is determined in step 1604 that the input is made by touching one of the icons in the item display area 1702:

In step 1607, it is determined which icon in the item display area 1706 has been touched and the item information for items in the category indicated by the icon is retrieved from the item database 215. The retrieved item information is stored in the temporary storage part 223.

In step 1608, it is determined whether the item information retrieved in step 1607 is a set item containing a drink. This step includes determination of whether the item type “40” for the set item is included in the first and second digits of the “item code”. If so, a further determination is carried out to determine whether an item code for drinks (i.e., an item code including “10” in the first and second digits) is contained in the “contents” information of the set item in consideration. As has been described above, it is to be noted that the item code for a drink contained in the “contents” information of the set item is the controlled item code 1001.

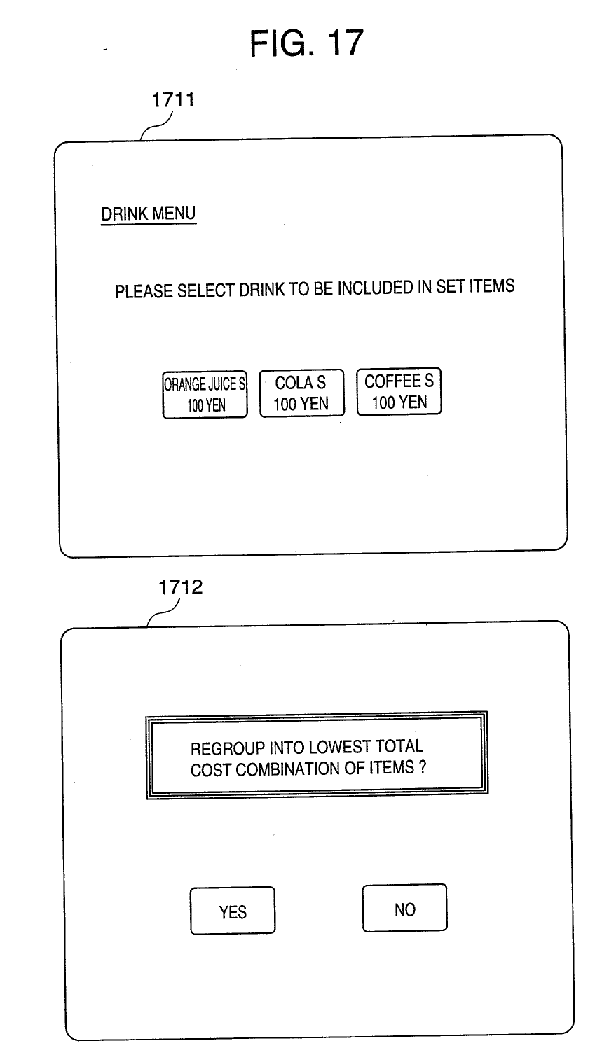

If a drink is contained in the set item, the item data retriever 216 refers to the drink single item information 90 stored in the item database 215 and retrieves the drink item information that matches with the controlled item code 1001. The second display controller 212 displays the result of retrieval as a group of icons in the item display area 1702 as shown by the screen 1711 of FIG. 17 (step 1609). When the touch position analyzer 213 determines that there is an input on the item display area 1702, the position information is used for determining which icon has been selected. Then, the item code of the item displayed on that icon is retrieved from the item database 215. Then, in step 1610, the “controlled item code” of the drink contained in the “contents” information of the set item in consideration is replaced by the “item code” of the retrieved drink. Then, the process proceeds to step 1611.

In step 1611, the position information obtained at the input position determining means 213 is used to determine whether there is an input on the quantity display area 1703. If there is an input on the quantity display area 1703, it is determined on which icon of the quantity display area 1703 the input has been made. Then, the quantity information indicated on that icon is retrieved.

In step 1612, the quantity information and the item information stored in the temporary storage part 223 are linked together and stored in the item selection data storage 222. In step 1613, the second display controller 212 displays the stored information in the ordered items display area 1707. Then, the process returns to step 1603.

(3) In a case where it is determined in step 1604 that the input is made by touching the “OK” icon 1705:

The item selection operation 1501 is terminated.

(4) In a case where it is determined in step 1604 that the input is made by touching the “cancel” icon 1704:

The process returns to step 1602. This is to delete the contents in the item selection data storage 222 to clear the contents that have been selected until then, and to perform item selection operation from step 1603 onwards.

Referring again to FIG. 13, after the item selection operation of step 1501, the process proceeds to step 1502 where a selection screen such as a screen 1712 shown in FIG. 17 is displayed for a selection of whether to perform an operation for regrouping items to a combination that is offered at the lowest total price. The process of retrieving the “lowest total price combination” will be described later. In step 1503, an input is made by the customer.

When the customer selects not to regroup the items to the “lowest total price combination”, the process proceeds to steps 1505 through 1508 to perform a printing operation. The printing operation will be described later.

If it is determined in step 1504 that an instruction is made to perform a regrouping operation to the “lowest total price combination”, a regrouping operation is performed (step 1509). The regrouping operation will be described below.

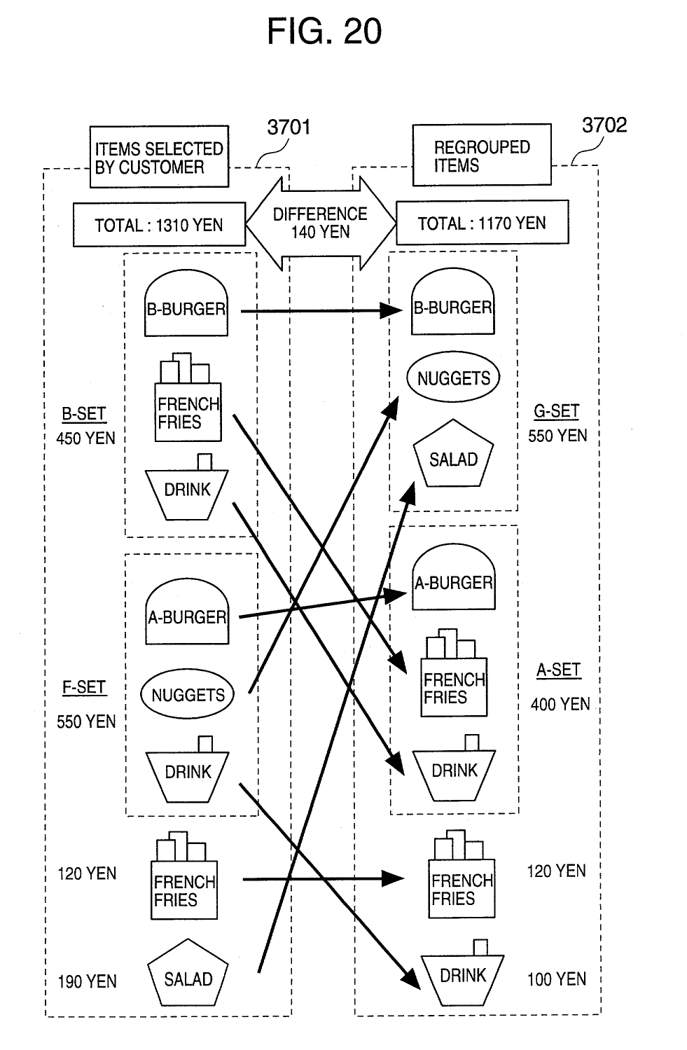

First of all, the object of the regrouping operation will be described with reference to FIG. 20.

In an example of FIG. 20, the customer orders items as a combination of items 3701 that includes a B-set (price: 450 yen), an F-set (price: 550 yen), French fries (price: 120 yen) and a salad (price: 190 yen). The total price of these items obtained by a simple addition is 1310 yen. However, if these items are appropriately regrouped, the same items are offered at a lower price. For example, when the items are regrouped into a combination of items 3702 that includes a G-set (price: 550 yen), an A-set (price: 400 yen), French fries (price: 120 yen) and a drink (price: 100 yen), the same items are offered at a total price of 1170 yen, providing a saving of 140 yen. Therefore, a regrouping operation is to be understood as an operation of automatically regrouping item selection information stored in the item selection data storage 222 into a combination of items including the same items but offered at a lower total price.

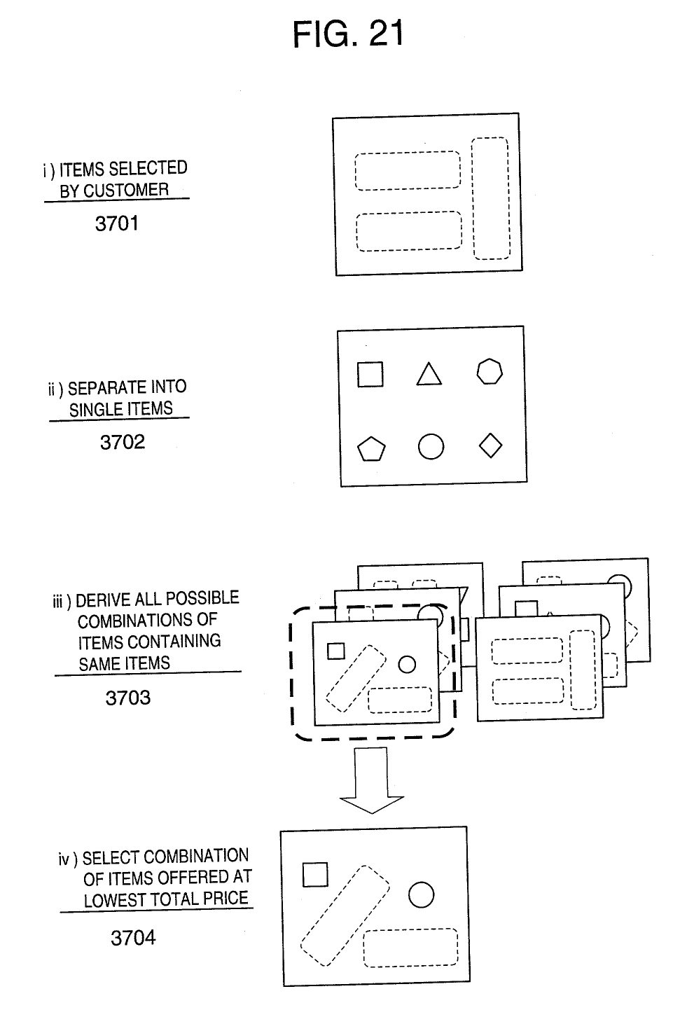

A process of regrouping operation will be described with reference to FIG. 21.

First, the item information of set items in the item information selected by the customer (3701) is separated into single item information (3702). In other words, all item information selected by the customer is separated into single item information. Thereafter, all possible combinations of items of the single item information are derived (3703). The combination offered at the lowest total price is selected from the derived combinations (3704). Information of the selected combination is stored in the temporary storage part 223.

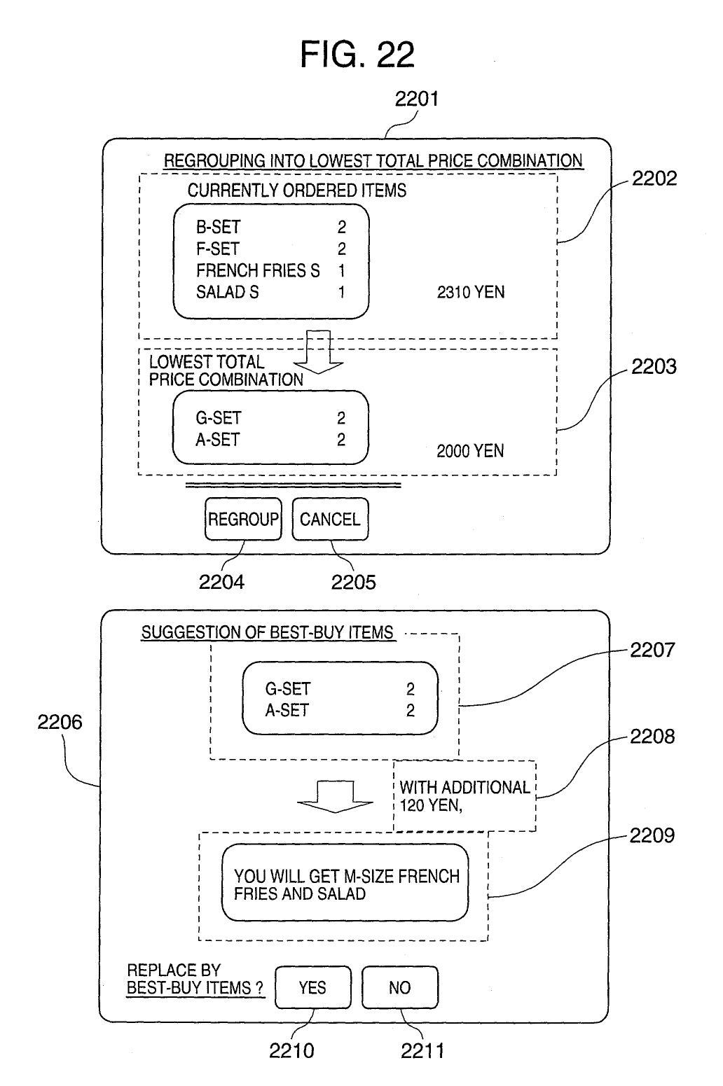

Referring again to FIG. 13, after the regrouping operation (step 1509), the process proceeds to a step of displaying the lowest total price combination (step 1510). In step 1510, a screen 2201 of FIG. 22 is displayed that includes the item information selected by the customer (currently selected items 2202) and the information of the lowest total price (lowest total price combination 2203) selected in step 1509. In step 1510, an “OK” icon 2204 and a “cancel” icon 2205 are displayed for the customer to decide whether or not to change the selected items into lowest total price combination.

In step 1511, an input at the “OK” icon 2204 or the “cancel” icon 2205 is detected by the touch position analyzer 213. In step 1512, the touch position analyzer 213 determines whether it is an input on the “OK” icon 2204 or on the “cancel” icon 2205 to determine whether to proceed to an operation of changing into the lowest total price combination.

If the input is on the “cancel” icon 2204 and it is determined that the customer has selected not to change to the lowest total price combination, the process proceeds to steps 1505 through 1508 for performing a printing operation.

If it is determined in step 1512 that there is an input on the “OK” icon 2204, the item information stored in the item selection data storage 222 is replaced by the item information of the lowest total price combination stored in the temporary storage part 223 (step 1513).

In step 1514, the “best-buy” set item information is retrieved. The process looks up the “best-buy” information 120 stored in the item database 706 of the server 7. The “best-buy” set information related to the item information of the set items of the item information stored in the temporary storage part 223 is retrieved and the price difference between the current set item information and the “best-buy” set information is derived. Further, the “contents” information of the current set item and the “contents” information of the “best-buy” set information are compared. With such comparison, item information is obtained of differing items that are not common between the current set item and the “best-buy” set item. This item information is stored in the temporary storage part 223.

In step 1515, screen 2206 of FIG. 22 is displayed that includes currently selected set information 2207, the derived price difference information 2208, the differing item information 2209 and an “YES” icon 2210 and a “NO” icon 2211 to decide whether to replace the order with the “best-buy” set item.

In step 1516, an input at the “YES” icon 2210 or the “NO” icon 2211 is detected by the touch position analyzer 213. In step 1517, the touch position analyzer 213 determines whether it is an input on the “YES” icon 2210 or on the “NO” icon 2211 to determine whether to proceed to an operation of replacement by the “best-buy” set item.

If it is determined in step 1517 that there is an input on the “YES” icon 2210, the process returns to step 1513 where the set item information stored in the item selection data storage 222 is replaced by the “best-buy” set item information stored in the temporary storage part 223 (step 1513). Accordingly, the process of retrieving and suggesting further “best-but” set items for the replaced item can be repeated.

If it is determined in step 1517 that the input is on the “NO” icon 2211 and it is determined that the customer has selected not to replace the order by the “best-buy” set item, the process proceeds to steps 1505 through 1508 for performing a printing operation.

Now the printing operation of steps 1505 through 1508 will be described.

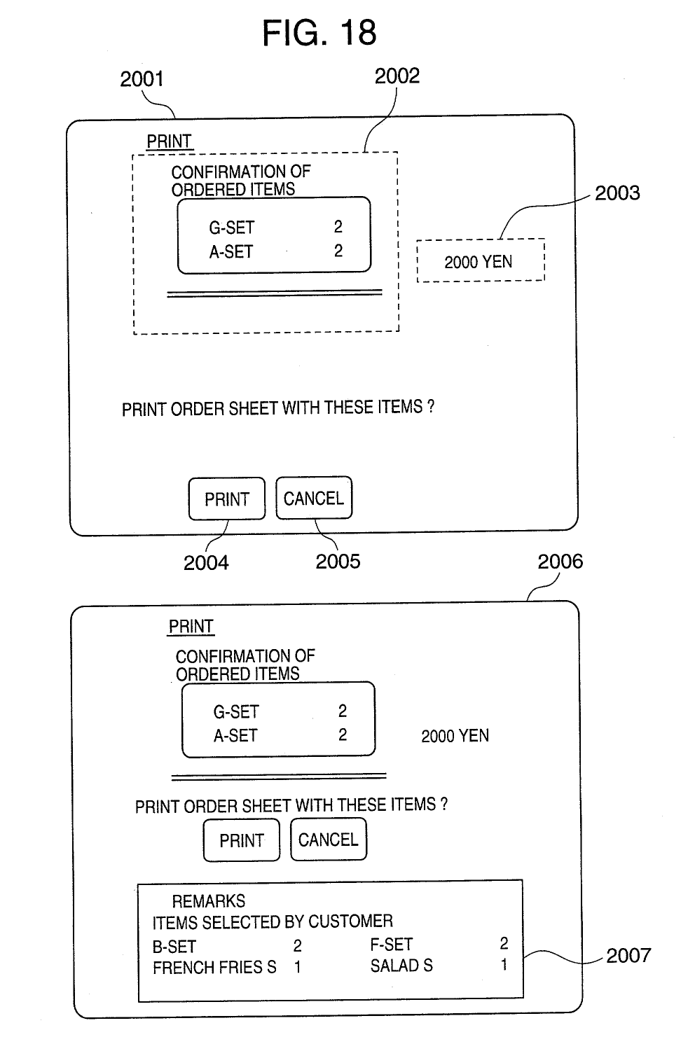

In step 1505, a screen 2001 shown in FIG. 18 is displayed that includes the item information 2002 stored in the item selection data storage 222, total price information 2003 of such item information, and a “print” icon 2004 and a “cancel” icon 2005 for confirming whether the displayed contents are to be printed. In step 1506, an input at the “print” icon 2004 or the “cancel” icon 2005 is detected by the touch position analyzer 213. In step 1507, the touch position analyzer 213 determines whether it is an input on the “print” icon 2004 or on the “cancel” icon 2005 to determine whether to proceed to the print operation.

If it is determined that the input is on the “cancel” icon 2005, the process returns to step 1501 (i.e., initial state).

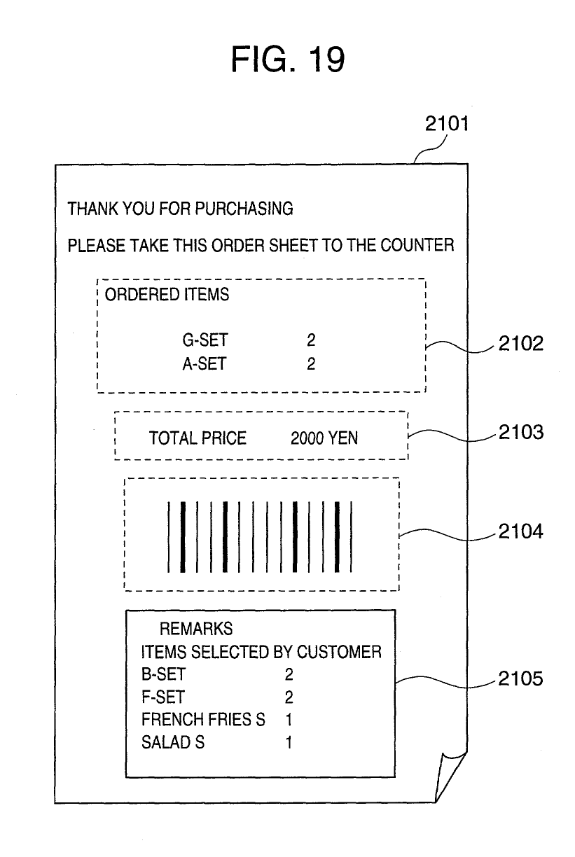

If it is determined that the input is on the “print” icon 2004, the process proceeds to step 1508 to operate the print controller 224 that supplies print instructions to the printing part 203 (step 1508). The information to be printed is stored in the item selection data storage 222. As shown in FIG. 19, the information to be printed includes item name 2102, total price of the items 2103, bar-code information 2104, which is the item information represented as a bar-code, and the selected item information 2105 that relates to the items selected by the customer in step 1501.

In a case where the printing operation is initiated by the branch extending from step 1517, that is to say, when the printing operation is performed after regrouping into the lowest total price combination but not replaced by the “best-buy” item, the process proceeds to step 1513. In step 1513, the information in the item selection data storage 222 is replaced by the item information having the same items as selected by the customer with the lowest total price combination, i.e., information in the temporary storage device 223. Therefore, the lowest total price combination information is printed as the item information 2102 stored in the item selection data storage 222 and as the bar-code 2104.

The selected item information 2105 that relates to the items selected by the customer may also be printed on the order sheet as shown in FIG. 19. This is to assist the customer who has purchased items for a plurality of persons in distributing items to each person after receiving the items.

In the following, an operation of retrieving the “best-buy” information will be described. In the embodiment described above, a set item to be offered for a particular set item is pre-stored in a table such as the “best-buy” set information 120. Such a table is looked up to retrieve the “best-buy” set information. However, it is also possible to retrieve a target set item (e.g., a set item containing a key item) from the set item information 110 and use the item information derived by a predetermined calculation step as the “best-buy” set information. In such a manner, it is not necessary to store the table for “best-buy” set item information in the item database 215, such as the “best-buy” information 120. Also, during maintenance of the item database 215, it is not necessary to consider correspondence between the set item and the “best-buy” set item. Therefore, maintenance of the item database 215 is facilitated.

The “best-buy” set item information may be derived in various ways. A combination that can be offered at the least price different from the currently selected item set may be provided as the “best-buy” set item information. It is also possible to provide a plurality of “best-buy” set item information of combinations of items that are offered at a price less than a certain price, so that the customer can choose between the offered plurality of “best-buy” set item information.

It is also possible to store particular items in the “best-buy” set item information 120 and to derive other items as the “best-buy” set item information.

Also, instead of determining the “best-buy” set item on the basis of price difference between combinations of items, a set item containing the items selected by the customer may be provided as the “best-buy” set item information. For example, when a customer selects a set item at a fast-food restaurant, he/she often selects a key item (in case of a hamburger shop, the key item is likely to be hamburgers. Therefore, in the following, the key item is also described as hamburgers) and then selects a set item that contains the selected key item. In such a case, set items containing the key item may be retrieved and presented to the customer, so as to automatically present set items that the customer may not be aware of, but once he/she becomes aware of such set items, he/she may wish to order them. This may be performed by presenting the set item with least price difference among set items containing the same key item (hamburger) or by presenting all set items containing the same key item (hamburger).

Further, after the regrouping operation, in a case where there are remaining single items that cannot be grouped into set items but can be regrouped into set items with additional single items, the set items obtained with additional single items can be suggested as the “best-buy” set item information. Such suggestion of adding a single item with a small additional amount of money can be achieved since the price of a set item is often lower than the sum of prices of single items. Therefore, with such a suggestion, the sales of the fast-food restaurant can be increased while giving a “good-buy” impression to the customers.

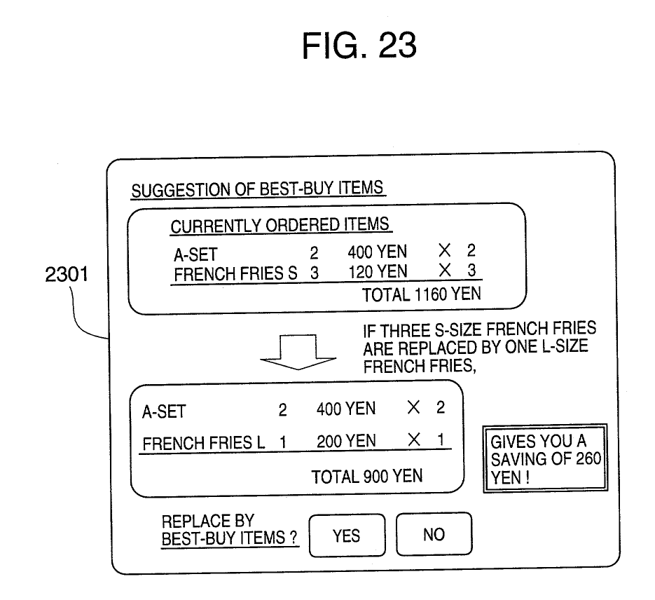

Also, information may be retrieved from the “equivalent item correspondence information 130” instead of the ““best-buy” set item information 120” and a plurality of items matching the information stored in the “equivalent item correspondence information 130” is ordered. In such a case, in step 1515, a screen 2301 of FIG. 23 that suggests replacing the currently selected plurality of items into a single larger sized item may be displayed on the second display 202. When the amount of a plurality of smaller items is equivalent to the amount of a single larger item, the larger item is often provided at a lower price. Therefore, the larger item can be suggested as a “best-buy” item. In this state, it is not known whether the items are to be consumed by each person or shared between several people. Therefore, a confirmation for replacing a plurality of smaller items with a larger item is performed in step 1516. Accordingly, the items can be selected as desired by the customer.

Again, if an operation of deriving the corresponding item such as S-size x 2 is equivalent to M-size and S-size x 3 is equivalent to L-size, there is no need to hold a table such as the “equivalent item correspondence information 130”.

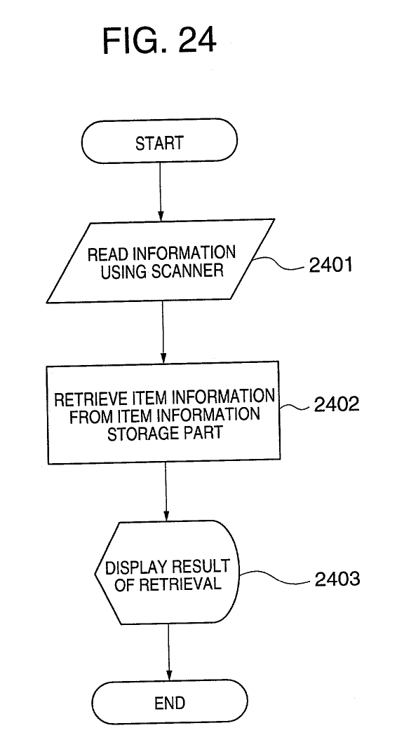

An item selection operation at the cash register 5 will be described with reference to a flowchart shown in FIG. 24.

As has been described above, the cash register 5 is installed at the counter of a hamburger shop. When the shop assistant receives from the customer an order sheet printed by the item-selecting device 2 and shown in FIG. 19, the shop assistant reads the bar-code information 2104 printed on the order sheet using the scanner 6. The bar-code information read by the scanner 6 is analyzed by the bar-code analyzer 501 and the information represented by the bar-code is extracted (step 2401).

In step 2402, the item data retriever 503 retrieves item information from the item database 502 on the basis of the bar-code information. In step 2403, the retrieved information is displayed on the display part 505 by the item information output control means 504. The shop assistant can accept orders on the basis of the displayed information. Also, although not shown in the figure, a printing device may be connected to the cash register 5 so that the retrieved information can be displayed on the display part 505 and can also be printed on a sheet that may be used for a further ordering process in the shop.

Accordingly, when the customer stands in front of the counter, the item selection has been completed and there is no need for the customer to select items in front of the counter. Therefore, the customer flow rate can be improved since the time taken for the customer to select items in front of the counter is reduced.

In the following, an update operation of the information storage part will be described.

Generally, for fast-food restaurants, item information changes frequently due to items offered for a limited time, new items being introduced and selling of some items being discontinued. Therefore, the item database needs to be updated for such frequent changes.

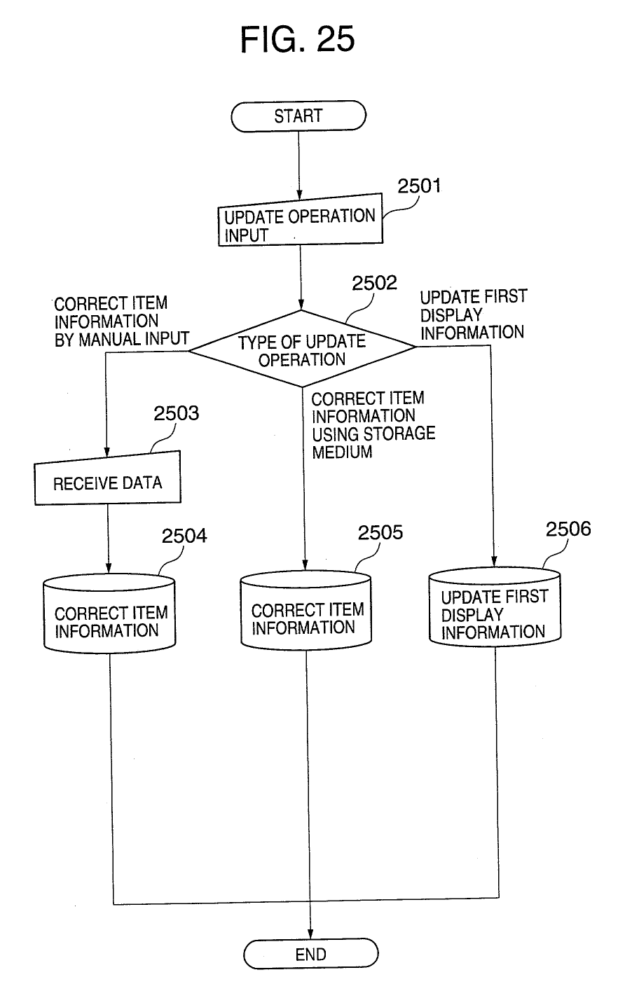

An updating operation will be described with reference to FIG. 25. FIG. 25 shows a flow chart of the updating operation performed at the server 7.

In step 2501, there is an input to the server 7 of an updating operation. In step 2502, the input analyzer 710 determines what type of update is intended. In the first embodiment, three types of updating operations are considered. A first type is an updating operation of item information using an input device such as a keyboard, a second type is an update operation of item information by reading a storage medium such as a CD-ROM and a third type is an updating operation of contents to be displayed on the first display 201 of the item-selecting device 2.

First, the updating operation of the item information via the input device will be described. If it is determined at step 2502 that the updating operation is via the input device, the process proceeds to step 2503 where inputs from the keyboard 703 and the mouse 704 are received. Then, the information in the item database 706 is updated based on the update information. Thereafter, the relevant information is transferred from the server 7 to the item-selecting device 2 and the cash register 5 via the network 1. The item-selecting device 2 and the cash register 5 update information in the respective item databases.

Second, the updating operation will be described of a case where it is determined at step 2502 that the updating operation is performed by reading a storage medium such as a CD-ROM. In step 2505, the item data updating means 708 instructs the storage medium reading device 701 of the server 7 to read information on the storage medium 702 loaded therein. The read out information is transferred to the item database 706 to update the information stored therein. In order to reduce time required for an updating operation, the updating operation using a storage medium may be performed when a vast amount of item information must be updated. Thereafter, the relevant information is transferred from the server 7 to the item-selecting device 2 and the cash register via the network 1. The item-selecting device 2 and the cash register 5 update information in the respective item databases.

Third, the updating operation will be described of a case where it is determined at step 2502 that the updating operation is an update operation of contents to be displayed on the first display 201 of the item-selecting device 2. In step 2506, the item data updating means 708 instructs the storage medium reading device 701 of the server 7 to read information on the storage medium 702 loaded therein. In step 2506, the read out information is transferred to the image information database 705. Thereafter, the relevant information is transferred from the server 7 to the item-selecting device 2. The item-selecting device 2 updates information in the image information database 214.

It is to be noted that if attributes are assigned to item information, it is not necessary to perform an updating operation for each change. For example, attributes may be assigned to distinguish between weekday prices and weekend prices when the prices are altered regularly for weekdays and weekends.

As has been described, item selection can be made by a customer via a dedicated item-selecting device 2, but an item selection operation may also be performed by the computer 3. In the following, an item selection operation by the computer 3 will be described. It is to be noted that a term “personal computer” as used the present embodiment is described but other devices capable of accessing the server 7 via the network may also be used for such an item selection operation. A mobile telephone having a network communication function is one of the devices capable of accessing the server 7.

Such a device is not provided with an item database. Therefore, when the item information is required, the device requests the server 7 to conduct item information retrieval. Such a retrieval procedure is performed as follows. For example, if the personal computer 3 transmits a retrieval request of item information of hamburgers to the server 7 via the network 1, the server 7 receives the request and starts up the item data updating means 708, retrieves item information of hamburgers from the item database 706 and transmits the retrieved item information as a response to the personal computer 3 via the network 1. Although not shown in the figure, the personal computer 3 is provided with a storage area for temporarily storing the item information. The retrieved item information is stored in the storage area.

A regrouping operation is also performed on the server 7. The regrouping process is performed as follows. If there is a need for a regrouping operation or a “best-buy” set information retrieving operation for the personal computer 3, the personal computer 3 transmits the item selection information stored in the storage part and an item regrouping request to the server 7 via the network 1. The server 7 retrieves the information using the item combiner 711 on the basis of the item selection information transmitted to the server. Then, the server 7 transmits the retrieved item information as a response to the personal computer 3. The “best-buy” set information retrieving operation is performed in a similar manner.

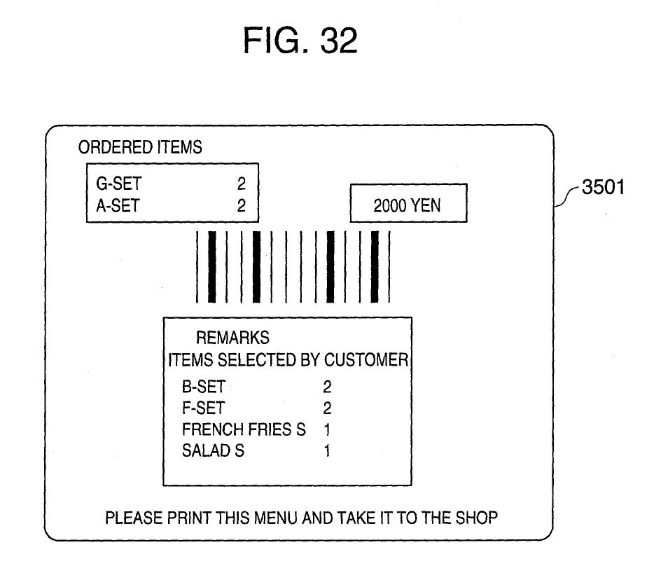

Generally, the personal computer 3 uses a general-purpose accessing software such as a browser. Therefore, a printing operation via the personal computer 3 is often performed only using a printing function provided on the screen of the personal computer 3. Therefore, in order to perform a printing operation for item information according to the first embodiment of the present invention, first of all, a screen 3501 shown in FIG. 32 is displayed on the personal computer 3. Then, this screen is printed via the printer 4 so that a service that is equivalent to item selection on the item-selecting device 2 can be offered. Thus by enabling item selection on the personal computer 3, it is not necessary for the customers to walk up to the dedicated item-selecting device 2.

In the present embodiment, a client device can retrieve information from the item database 706 of the server 7. Therefore, it is not necessary to store item information in the client device. Further, updating the item information in the server 7 is sufficient for the client device to retrieve the latest information.

As has been described above, in the case of the personal computer 3, the screen displayed on the personal computer 3 is printed. However, in the case of a portable terminal, the customer can carry the portable terminal whereon the screen can be displayed. Therefore, the screen itself can be saved in the portable terminal so that the customer can present the screen to the shop assistant and the shop assistant can read the screen by the bar-code scanner.

In the following, a second embodiment of the present invention will be described.

In the first embodiment of the present invention described above, an order is input to the cash register 5 by reading the bar-code information on the printed order sheet using the scanner 6 of the cash register 5 installed at the shop. However, an order may be input to the cash register 5 by transferring item selection information determined at the item-selecting device 2 to the cash register 5 by a communication over the network 1.

The configuration of the system of the second embodiment of the present invention will be described below.

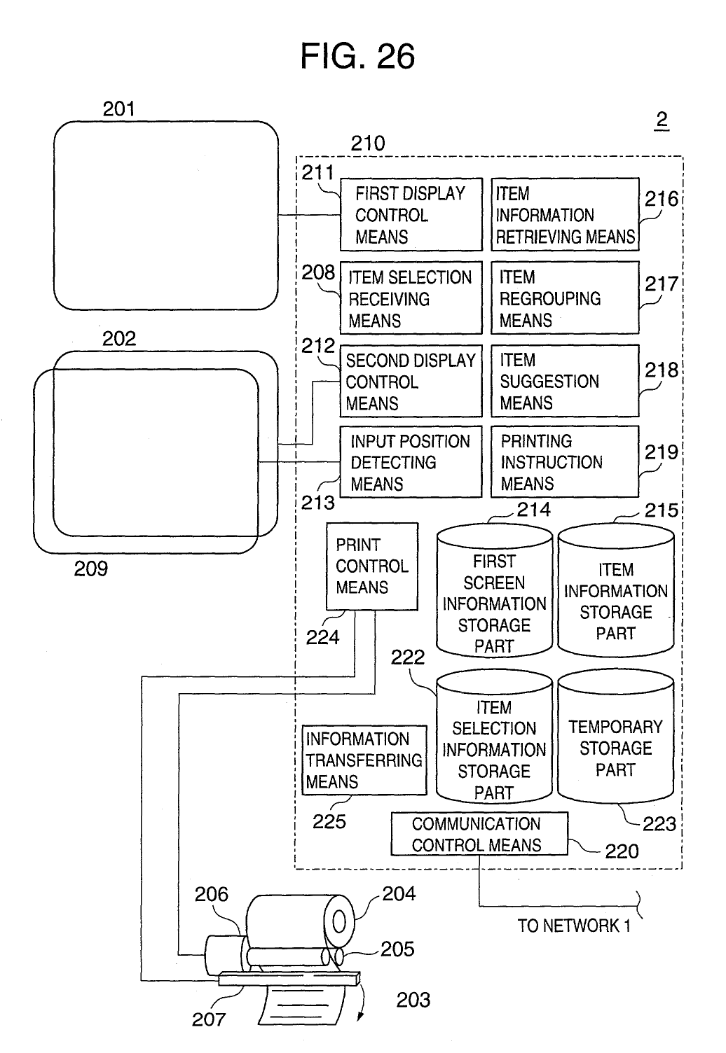

The overall system configuration will not be described in detail since it is similar to the configuration of the first embodiment shown in FIG. FIG. 26 is a block diagram showing an item-selecting device 2 of a second embodiment of the present invention. The item-selecting device 2 shown in FIG. 26 differs from the item-selecting device 2 shown in FIG. 3 in that information transferring means 225 for transferring item selection information to the server 7 is additionally provided in the control means 210. Other elements are similar to those of the first embodiment of the present invention, and will not be described in detail.

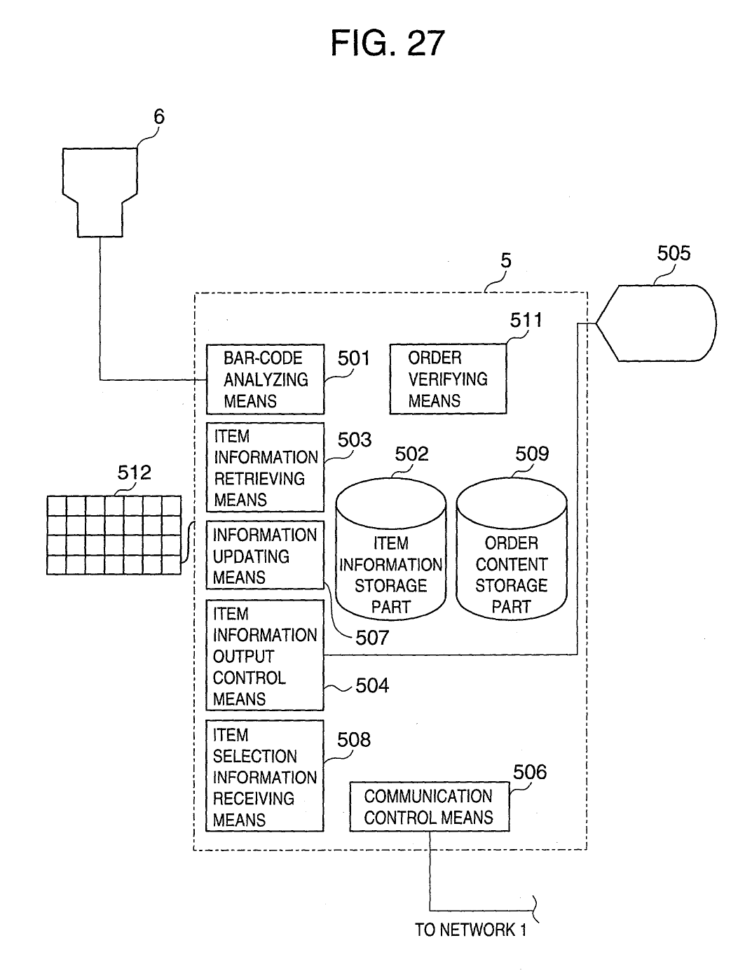

FIG. 27 is a block diagram showing a cash register 5 of the second embodiment of the present invention. The cash register 5 of the second embodiment shown in FIG. 27 differs from the cash register 5 of the first shown in FIG. 4 in that elements 508, 509 and 511 are provided. Item selection information receiving means 508 receives item selection information incoming via the network 1. Item data retriever 503 retrieves from the item database 502 the item information contained in the information received by the item selection information receiving means 508 and stores the item information into an order content storage part 509. The order content storage part 509 stores item information ordered by the customer. Order verifying means 511 analyzes the order code input via the keyboard 512 and retrieves item information ordered by the customer from the order content storage part 509 on the basis of the order code information. Other elements are similar to those of the first embodiment of the present invention, and will not be described in detail.

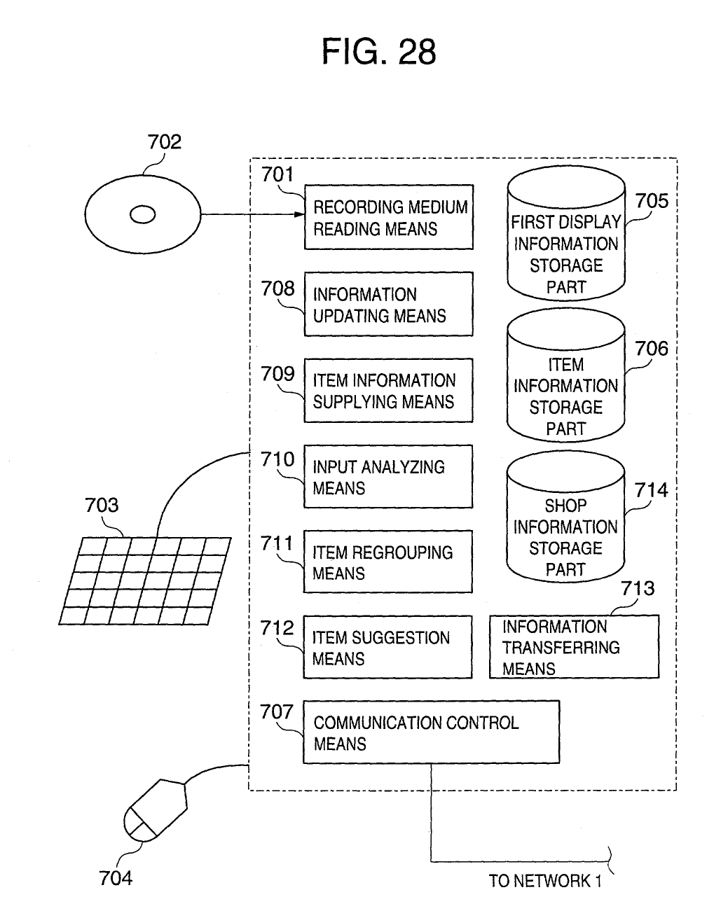

FIG. 28 is a block diagram showing a server 7 of the second embodiment of the present invention. The server 7 of the second embodiment shown in FIG. 28 differs from the server 7 of the first shown in FIG. 5 in that a shop information storage part 714 and information transferring means 713 are additionally provided. The shop information storage part 714 stores address information of each shop on the network 1. The information transferring means 713 uses the address information to transfer item selection information sent from the item-selecting device 2 to the cash register 5 of the intended shop.

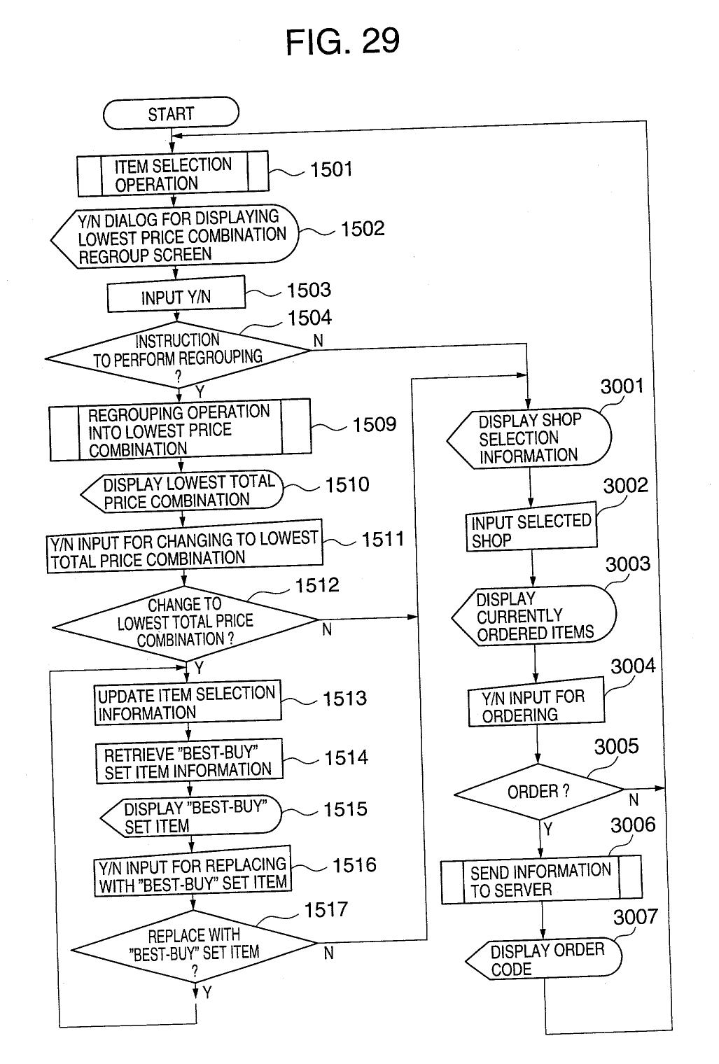

In the following, an item selecting operation of the item-selecting device 2 of the second embodiment will be described with reference to FIG. 29.

In the flowchart of FIG. 29, steps 1501 through 1517 are similar to those shown in the flowchart of the first embodiment shown in FIG. 13. Therefore, detailed description of those steps is omitted. The flowchart of FIG. 29 differs from the flowchart shown in FIG. 13 in that, after steps 1504, 1512 and 1517, the process of the first embodiment proceeds to step 1505, whereas in the second embodiment, the process proceeds to step 3001. Steps 3001 through 3007 relate to a process of sending the item selection information selected by the customer to the server 7. This process is performed by the information transferring means 225. In the following, the item selection information sending process of steps 3001 through 3007 will be described.

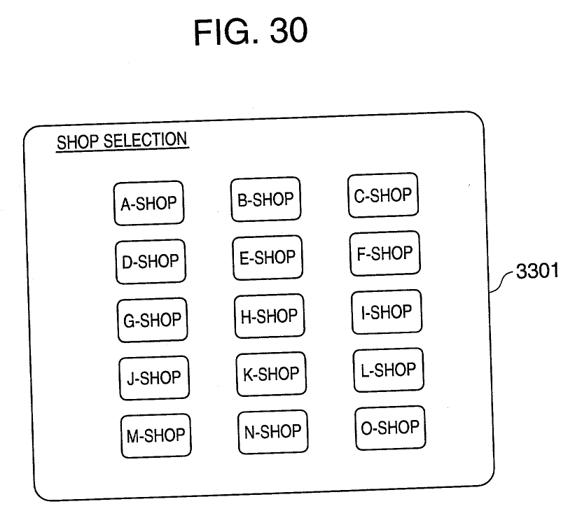

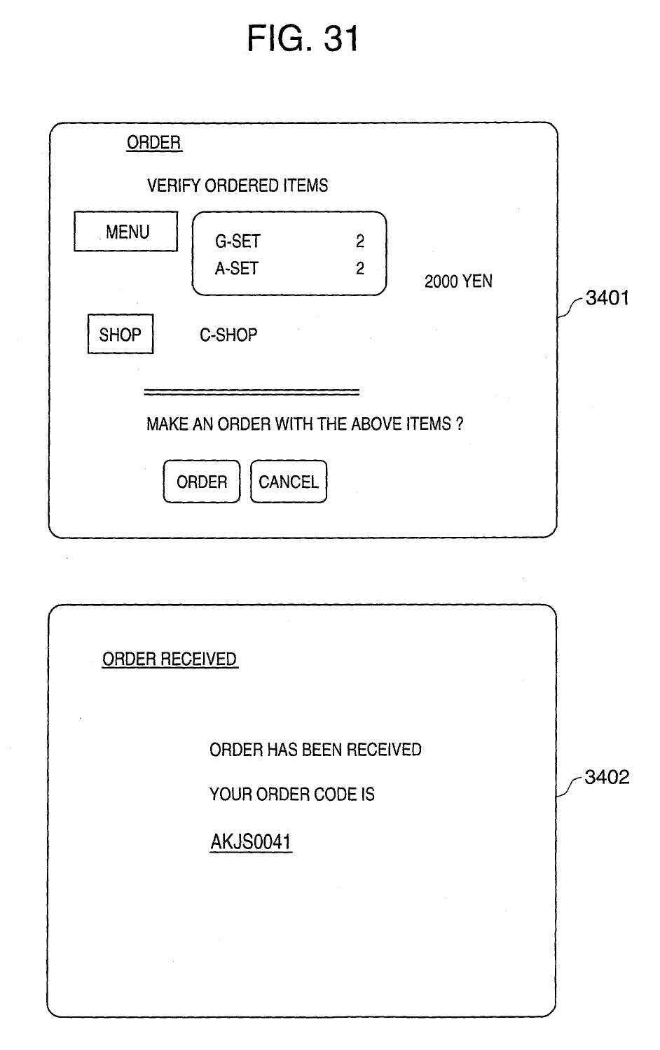

In step 3001, shop selection information is displayed on the second display 202 as shown by screen 3301 in FIG. 30. In step 3002, a shop is selected. In step 3003, as shown by screen 3401 of FIG. 31, currently ordered content, selected shop information and icons for determining whether to order according to the displayed information are displayed. If there is an input on either one of the icons (step 3004), it is determined on which of the icons the input has been made (step 3005).

If an input is made on an icon for not making an order, the process returns to an initial state of step 1501.

If an input is made on an icon for making an order, the process proceeds to step 3006 where the shop selection information accompanied by the shop information and a predetermined ordering code is sent to the server 7. In step 3007, a message indicating that the transmission has been completed and the ordering code are displayed as shown by screen 3402 of FIG. 31.

The customer can order the preselected items by providing this ordering code to the shop assistant at the shop.

In the following, a transferring process performed by the server 7 will be described.

This transferring process is performed by information transferring means 713 in the server 7.

When the order information is received from the item-selecting device 2, the information transferring means 713 retrieves shop information contained in the received order information. The shop information is matched with the information stored in the shop information storage part 714 to retrieve a network address of the shop whereto the information is to be transferred. Then, the ordering information from the item-selecting device 2 is transferred to the retrieved address.

An operation by the cash register 5 will be described below.

At the cash register 5, when the item selection information receiving means 508 receives information from the item-selecting device 2 and transferred by the server 7, the item data retriever 503 retrieves the item information that matches to the item selection information contained in the information from the item database 502. The ordered item information and the ordering code information contained in the transferred information are stored as a pair (order content information) in the order content storage part 509.

Thereafter, the shop assistant is informed of the order code by the customer and inputs the order code using the keyboard 512. Then, the order verifying means 511 retrieves the order content information from the order content storage part 509 using the order code information as key information. Then, the order information output control means 504 generates an instruction to output the retrieved order content information on the display 505.

With such a configuration, a printing operation needs not be performed, and thus a paperless system can be provided.

It is to be noted that, in the second embodiment, the order information is transferred to the cash register 5 before the customer arrives at the shop. Therefore, there is an advantageous effect that the visiting of the customers can be known in advance.

It is also possible to automatically activate the display 505 at the time when a storing operation on the order content storage part 509 is performed by the item data retriever 503. With such a system, the shop assistant is immediately informed that an order has been made. Therefore, the shop assistant can prepare the ordered items by the time the customer arrives at the shop. Therefore, the customer can receive the ordered items at the time he/she arrives the shop and the time the customer stands in front of the counter is further reduced. Therefore, the customer flow rate can be further increased.

However, it may happen that the customer who has made an order does not come to the shop or comes at a later time. In the case of offering food such as hamburgers, if quite a long time elapses after cooking the food, the food may become cold and can no longer be in a state appropriate for being offered to the customer. Therefore, the items are wasted since ordered items must be prepared again. In order to avoid such a problem, a valid time period for the received orders may be determined for the item-selecting device 2. If the customer is informed that the order is only valid if he/she comes to the shop within the valid time period, the customer is likely to come to the shop within the valid time period. Accordingly, it is possible to reduce the waste of food or the need to prepare the food again. Also, there is often a change in items offered at fast-food restaurants. Therefore, if a valid term is set in the case of the first embodiment of the present invention, the customer is encouraged to visit the shop before items offered at the shop change. This may avoid a case that the ordered items are those items no longer offered at the shop.

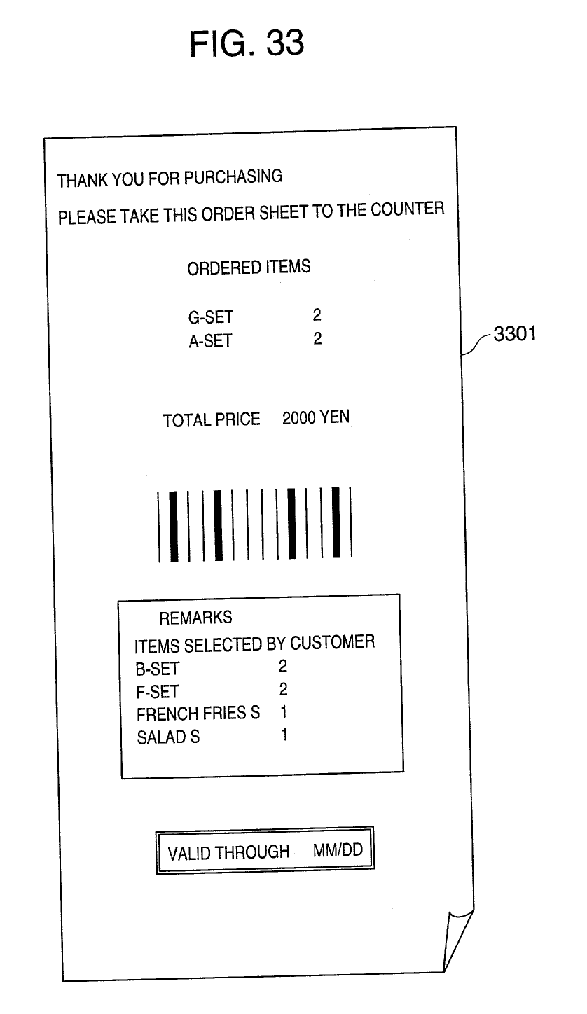

It is preferred that information related to valid time period and valid term be provided in some form that can be presented to the customer. For example, valid time period and valid term can be printed on a sheet of paper printed at the item-selecting device 2 as shown by sheet 3001 of FIG. 33.

Also, for the first and second embodiments of the present invention, the item regrouping function or the “best-buy” set item suggesting function may also be provided on the cash register 5. With such a configuration, a customer who has not selected items in advance can order the items by using the system of regrouping the items to the lowest total price combination by simply identifying the items to be ordered to the shop assistant at the counter in the shop.

In such a case, the time required for the customer to select items is not completely dispensed with. Therefore, compared to the cases where the customer has selected items in advance at locations other than the counter, e.g., at the item-selecting device 2, the customer stays in front of the counter for a longer time. In order to avoid this, a discount price can be set for a case where item selection has been performed at locations other than the counter, e.g., at the item-selecting device 2, and not at the cash register 5. Thus, it can be expected that more customers will perform item selection in advance.

Further, in the present embodiment, the item information is displayed on the second display 202 as text information. However, in order to facilitate the item selection operation by the customer, the item information may be displayed as image information including moving pictures and still pictures or information in which image information and text information are combined. Also, a language selection function may be provided in the initial state or during item selection, enabling the item-selecting device 2 to be use by tourists from foreign countries. Such an embodiment is useful in popular sites visited by many tourists from foreign countries. With the system of the present invention, an oral conversation between the shop assistant and the customer is not necessary. Therefore, the shop assistant can offer the item ordered by the customer who speaks any foreign language adapted to the item-selecting device 3.

Further, the present invention is not limited to these embodiments, and variations and modifications may be made without departing from the scope of the present invention.

The present application is based on Japanese priority application No. 2001-340486 filed on Nov. 6, 2001, the entire contents of which are hereby incorporated by reference.

What is claimed is:

1. An item-selecting device comprising:
item data retriever for retrieving individual price information for items offered as single items and set price information for items offered as sets of items from an item information storing part;
item selection receiving means for receiving item selection information of a selection of items selected by a user, said selection of items including at least one single item and at least one set of items;
item combiner for regrouping said selection of items into at least one combination of items consisting of the same items as included in said selection and choosing a combination offered at lowest total price by referring to said individual price information and said set price information; and
output means for outputting the result obtained from said item combiner.

2. The item-selecting device as claimed in claim 1, wherein said output means is printing means.

3. The item-selecting device as claimed in claim 1 wherein said output means is transmitting means through a network.

4. The item-selecting device as claimed in claim 1 wherein said output means is display.

5. The item-selecting device as claimed in claim 1, said item data retriever further retrieving additional information of set items from said item information storing part,
wherein said item-selecting device further comprises an item suggestion means for suggesting new selection of items by modifying said combination of items obtained from said item combiner using said additional information,
said output means further outputs the result obtained from said item suggestion means.

6. The item-selecting device as claimed in claim 1, further comprising second item combiner for replacing items in said combination of items regrouped in said item combiner by another set of items, said output means outputting the result obtained from said second item combiner.

7. The item-selecting device as claimed in claim 1, further comprising third item combiner for replacing a plurality of same kind of items in said combination of items regrouped in said item combiner by an item of the same kind of a different size, said output means outputting the result obtained from said third item combiner.

8. A computer readable medium having program codes stored thereon for causing a computer to perform item selection, comprising:
first program code means for retrieving individual price information for items offered as single items and set price information for items offered as sets of items from an item information storing part;
second program code means for receiving item selection information of a selection of items selected by a user, said selection of items including at least one single item and at least one set of items;
third program code means for regrouping said selection of items into at least one combination of items consisting of the same items as included in said selection and choosing a combination offered at lowest total price by referring to said individual price information and said set price information; and
fourth program code means for outputting the result obtained from said item combiner.

9. The computer readable medium as claimed in claim 8, said first program code further retrieves additional information of set items from said item information storing part,
wherein said computer readable medium further comprises a fifth program code means for suggesting new selection of items by modifying said combination of items obtained from said item combiner using said additional information,
said fourth program code means further outputting the result obtained from said item suggestion means.

10. The computer readable medium as claimed in claim 8,
further comprising sixth program code means for regrouping said selection of items by replacing items in said combination of items regrouped in said third program code means by another set of items, said fourth program code means outputting the result obtained from said sixth program code means.

11. The computer readable medium as claimed in claim 8,
further comprising seventh program code means for regrouping said selection of items by replacing a plurality of same kind of items in said combination of items regrouped in said third program code means by an item of the same kind of a different size, said fourth program code means outputting the result obtained from said seventh program code means.

12. An item-selecting system comprising an item-selecting device and a cash register,
said item selecting device including:
an item data retriever for retrieving individual price information for items offered as single items and set price information for items offered as sets of items from an item information storing part;
item selection receiving means for receiving item selection information of a selection of items selected by a user, said selection of items including at least one single item and at least one set of items;
item combiner for regrouping said selection of items into at least one combination of items consisting of the same items as included in said selection and choosing a combination offered at lowest total price by referring to said individual price information and said set price information; and
first output means for outputting the result obtained from said item combiner, and
said cash register including:
reading means for reading said result output from said first output means, and
second output means for outputting a result of said reading of said reading means.

13. The item-selecting system as claimed in claim 12, wherein said first output means is a printing means and said reading means reads a printed result of said printing means.

14. The item-selecting system as claimed in claim 12, wherein said first output means is a transmitting means via a communication line and said reading means receives a transmission result from said transmission means.

15. The item-selecting system as claimed in claim 12, said item data retriever further retrieving additional information of set items from said item information storing part,
wherein said item-selecting device further comprises an item suggestion means for suggesting new selection of items by modifying said combination of items obtained from said item combiner using said additional information,
said output means further outputs the result obtained from said item suggestion means.

16. The item-selecting system as claimed in claim 12, further comprising second item combiner for replacing items in said combination of items regrouped in said item combiner by another set of items, said output means outputting the result obtained from said second item combiner.

17. The item-selecting system as claimed in claim 12, further comprising third item combiner for replacing a plurality of same kind of items in said combination of items regrouped in said item combiner by an item of the same kind of a different size, said output means outputting the result obtained from said third item combiner.

18. A method to be carried out by the operation of a computer, comprising the steps of:
a) retrieving individual price information for items offered as single items and set price information for items offered as sets of items from an item information storing part;
b) receiving item selection information of a selection of items selected by a user, said selection of items including at least one single item and at least one set of items;
c) regrouping said selection of items into at least one combination of items consisting of the same items as included in said selection and choosing a combination offered at lowest total price by referring to said individual price information and said set price information; and
d) outputting the result obtained from said item combiner.
